(19) United States
(12) Patent Application Publication
(10) Pub. No.: US 2024/0066644 A1
(43) Pub. Date: Feb. 29, 2024

(54) METHOD OF DESIGNING AND PRODUCING FIBER-REINFORCED POLYMER PISTONS

(71) Applicant: AWA FORGED COMPOSITES, LLC, Rolling Hill Estates, CA (US)

(72) Inventors: Bryan Gill, Rancho Palos Verdes, CA (US); Brennan C. Lieu, Torrance, CA (US); Aaron Guo, Palos Verdes Estates, CA (US)

(73) Assignee: AWA FORGED COMPOSITES, LLC, ROLLING HILL ESTATES, CA (US)

(21) Appl. No.: 18/387,952

(22) Filed: Nov. 8, 2023

Related U.S. Application Data
(63) Continuation of application No. 17/514,214, filed on Oct. 29, 2021, now abandoned.
Application No. 17/514,214 is a continuation-in-part of application No. 16/042,350, filed on Jul. 23, 2018, now abandoned.
(60) Provisional application No. 62/541,535, filed on Aug. 4, 2017.
(60) Provisional application No. 62/535,821, filed on Jul. 21, 2017.
(60) Provisional application No. 63/107,747, filed on Oct. 30, 2020.

(51) Int. Cl. B23P 15/10; F02F 3/00

(52) U.S. Cl. CPC B23P 15/10; F02F 3/0023; F02F 3/0084; B23P 2700/04; F02F 2200/06; F05C 2201/021; F05C 2201/0406; F05C 2201/0409; F05C 2201/0412; F05C 2201/0421; F05C 2201/0424; F05C 2201/0436; F05C 2201/0466; F05C 2201/0472; F05C 2201/0481; F05C 2201/0496; F05C 2203/0808; F05C 2203/0886; F05C 2225/00

(57) ABSTRACT

A method is provided for designing and producing fiber-reinforced polymer (FRP) pistons. Pistons made with FRP have a lower mass than prior art metal pistons conferring advantageous engine efficiency and stability. FRP pistons also increase the thermal efficiency of engines by having a lower thermal conductivity, with tighter piston-to-bore clearance, and/increased air-fuel ratio than pistons of metal. The technical parameters of the piston are identified, and a piston body blank is produced. The blank is then machined, a bearing surface for the pin bore is created, the piston blank is optionally coated, is optionally subjected to Heavy Metal Ion Implantation (HMII) treatment and is subjected to sodium silicate impregnation to produce the final pistons.

### RELATED APPLICATIONS

This application is a continuation of U.S. utility patent application Ser. No. 17/514,214, filed 29 Oct. 2021, which is a continuation in part of U.S. utility application Ser. No. 16/042,350 filed Jul. 23, 2018, now abandoned, titled, “Method of designing and producing high performance carbon ceramic pistons” by inventor Bryan Gill, which claimed priority to U.S. provisional application No. 62/541,535 filed Aug. 4, 2017, and 62/535,821 filed Jul. 21, 2017, as well as to U.S. provisional application No. 63/107,747 filed Oct. 30, 2020, entitled, “Method of Designing and Producing High Performance Composite Pistons” by inventors Bryan Gill and Brennan C. Lieu. Each of these applications is hereby incorporated by reference herein in their entireties.

### FIELD OF INVENTION

The present application relates to manufacturing components which are located in an internal combustion engine. Specifically, this invention pertains to designing and producing pistons in an engine.

### BACKGROUND

Pistons are well known structures that support the combustion of internal combustion engines. Pistons move up and down within the cylinders of engines. Generally, internal combustion engines use a standard four-stroke cycle. The first step in the cycle is the intake stroke, in which the piston moves down the cylinder and draws in air and fuel. The second step in the cycle is the compression stroke, in which the piston moves up the cylinder to compress the air and fuel mixture. The third step in the cycle is the ignition stroke in which a spark is used to ignite the air and fuel mixture and push the piston down the cylinder with high combustion pressures. The fourth and final step in the cycle is the exhaust stroke, in which the piston moves up and the burnt fumes are expelled from the combustion chamber.

Pistons are typically made of steel or aluminum alloys. High performance pistons are almost exclusively high-tech aluminum alloys, which are generally lightweight and have a high yield strength. In high performance applications, such as drag racing aluminum alloys such as Aluminum 2014-T6 and Aluminum 7075-T6 are used.

High-tech forged aluminum alloy pistons generally withstand the compressive forces in the combustion chamber of high-performance race engines. However, forged aluminum alloys melt, yield, and fatigue from extreme temperatures of combustion. The air-fuel ratio in an internal combustion engine is typically limited by the service temperature of pistons, because increasing the air-fuel ratio increases the combustion temperature which subsequently destroys aluminum pistons. However, increasing the air-fuel ratio in an internal combustion engine increases the power and fuel efficiency. Further, to accommodate a large coefficient of thermal expansion (23-26 ppm per degrees Celsius for Aluminum 7075-T6), aluminum pistons use a large piston-to-bore clearance, which results in decreased performance.

Pistons must be accelerated to very high speeds within an engine. Therefore, even a small reduction in weight of a piston results in a decrease in amount of energy required for an engine to accelerate thereby increasing the performance of the engine. Further, lighter pistons reduce the momentum of the engine, which increases safety and reduces the wear on other components.

Therefore, there is a need for lightweight pistons that have a low coefficient of thermal expansion and a high service temperature.

### SUMMARY OF THE INVENTION

An aspect of the invention described herein provides a method for manufacturing at least one fiber-reinforced polymer piston, the method including: determining at least one dimension of the at least one fiber-reinforced polymer piston selected from: dome area, piston ring lands, pin bore area, skirt area, for designing and producing a piston body blank comprising at least 50% fiber-reinforced polymer by volume; machining the piston body blank for integral parts of the piston to obtain a piston blank; generating a bearing surface for a pin bore in the piston blank, the bearing surface having a surface roughness of 0-32 Ra; finishing the piston blank to obtain the fiber-reinforced polymer piston; and impregnating the piston with sodium silicate impregnation. The piston blank has a near net shape of at least one piston.

In some embodiments of the method, producing the piston body blank further includes building a one-piece, a two-piece, or a three-piece piston body blank. An embodiment of the method further includes producing the piston body blank by at least one process selected from: contour compression molding; injection molding; over mold injection molding; creating a standard FRP Billet Rod; and resin injection molding; or alternatively manufacturing a standard FRP Billet Rod and machining the standard FRP Billet rod to be bonded with a thermoplastic or thermoset adhesive to one part or two parts. In some embodiments of the method, after finishing, the piston blank is subjected to heavy metal ion implantation treatment.

An embodiment of the method after the step of finishing, further includes applying at least one of: a vapor deposited coating, and a plasma spray coating, on the piston blank or the integral parts, the coating is at least one selected from: a diamond-like carbon coating, a technical ceramic coating, a metal coating, and a molybdenum disulfide coating.

In some embodiments after finishing, the method further includes applying an electroplated coating on the piston blank or the integral parts, the electroplated coating is a metal selected from aluminum, brass, cadmium, chromium, copper, gold, iron, molybdenum, nickel, silver, titanium, and zinc. In an embodiment of the method, the integral parts include at least one of outside diameter, pin bore, ring lands, and dome. In some embodiments after finishing, the method further includes applying a painted coating to the piston blank or the integral parts, the coating is at least one selected from: a ceramic paint coating, a metallized paint coating, a pure molybdenum paint coating, a graphite paint coating, and a molybdenum disulfide paint coating.

In some embodiments after finishing, the method further includes applying an anti-friction dry film coating to the piston blank or the integral parts, the anti-friction dry film is at least one selected from: molybdenum disulfide, tungsten disulfide, and graphite. In an embodiment of the method, finishing the piston blank further includes at least one process selected from: milling, grinding, turning, lapping, polishing, vibratory finishing, and electropolishing.

An aspect of the invention described herein provides a fiber-reinforced polymer piston including a piston blank having at least 50% fiber-reinforced polymer by volume, the piston blank selected from a one-piece piston body blank, two-piece piston body blank, or three-piece piston body blank. In some embodiment, the piston body blank is selected from: a contour compression molded part, an injection molded part, an over mold injection molded part, a resin injection molded part, a standard FRP Billet Rod, a standard FRP Billet rod machined to be bonded with a thermoplastic or a thermoset adhesive to one part, and a standard FRP Billet rod that has been machined to be bonded with a thermoplastic or a thermoset adhesive to two parts.

In some embodiments, the piston blank further includes at Least one of: a vapor deposited coating, and a plasma sprayed coating, of at least one material selected from: a diamond-like carbon coating, a technical ceramic coating, a metal coating, and a molybdenum disulfide coating.

In some embodiments, the piston blank further includes an electroplated coating of at least one metal selected from: aluminum, brass, cadmium, chromium, copper, gold, iron, molybdenum, nickel, silver, titanium, and zinc. In some embodiments the piston blank includes the piston body blank having machined integral parts. In some embodiments, the piston blank further includes a painted coating of at least one material selected from: a ceramic paint coating, a metallized paint coating, a pure molybdenum paint coating, a graphite paint coating, and a molybdenum disulfide paint coating. In some embodiments, the piston blank further includes an anti-friction dry film coating of at least one material selected from: molybdenum disulfide, tungsten disulfide, and graphite.

An aspect of the invention described herein provides a method for producing a fiber-reinforced polymer piston blank, the method including: designing and producing a piston body blank comprising at least 50% fiber-reinforced polymer by volume; machining the piston body blank for integral parts of the piston blank thereby obtaining the piston blanks; and generating a bearing surface for a pin bore in the piston blank, the bearing surface having a surface roughness of 0-32 Ra.

In some embodiments of the method, the bearing surface for the pin bore is machined into the piston blank by at least one process selected from: milling, honing, grinding, turning, lapping, polishing, vibratory finishing, and electropolishing. In some embodiments after creating, the method further includes inserting and bonding technical ceramic or metal wrist pin inserts into the pin bore. The present invention pertains to a new method of designing and producing a composite piston using compression molded, chopped composite material that is machinable after being formed, along with a design process that allows several different designs to be machined from a shaped mold of composite material.

Automotive pistons are well known structures that support the combustion of internal combustion engines. High performance pistons are designed to have light weight and high strength, allowing the pistons to specifically designed to reduce reciprocating mass (allowing faster response) and yet be sufficiently durable for competition or rigorous use, while maintaining ring stability through the cycle. High performance and exotic engines are not the only engines in which may benefit from this technology. Pistons can, for example, be replaced for increased performance or to achieve better fuel economy. The present invention is directed to a new method of manufacturing and designing high performance pistons, which aims to increase performance thereof while maintaining a high degree of manufacturing economy.

The present invention relates to a new method of designing and producing composite pistons, and carbon ceramic piston designs that do not require specific molds or different sizes, those with different can be formed into a shape using a compression molding technique. The resulting material is non-directional and conforms to the shape of the mold, wherein the chopped fibers are supported within a matrix in random directions to produce an overall quasi-isotropic material system. Using this material, the piston design process benefits and can utilize the fact that this material system is machinable after being formed. Further provided is an efficient design method that utilizes the chopped composite material system to create a piston blank that is adaptable to different diameters while minimizing lost materials during the machining process. Once the piston design is machined, the piston can then be plated, bushed in the pin areas and anti-friction plated or coated in regions that engage in moving contact. For example, anti-friction properties may be enhanced on smoothly machined surfaces by treatments which form or convert to nitride or carbide hard ceramic surface functionality.

The present new design and manufacturing method of composite pistons using chopped carbon ceramic material, reduces material waste, reduces engineering design expense for each piston design, and reduces the cost of providing composite pistons to consumers. Various molds are used to accommodate a plurality of piston designs, sizes, diameters, and shapes, whereby the resulting piston blank from the single mold process is machined to a specific size and shape for the desired piston.

For example, a fiber/composite piston blank may have a body that can be machined down to a specific diameter, and may possess bosses that may be through-bored and bushed to receive a connecting rod wrist pin at one or more different offsets from the piston top, or have a piston upper surface that can be machined to accommodate valve faces moving at oblique angles near the top-of-stroke position. The piston blank may also include a separately molded piston skirt assembly, that is supported by or fastened to the body of the piston, thus adapting the piston to engines of different bore, different stroke, and or internal clearances. The resulting assembled or machined piston blank may be then connected to a connecting rod to produce a high-performance piston at a reduced cost and weight compared to traditional methods of aluminum pistons in the market.

The present invention substantially differs in design elements and method steps from the prior art by forming a piston blank or preform, that rather than being a roughly final form, is machined, cut or altered to matched one of a number of potential patterns, and then finish-machined. The overall design and production method fills a need in the art for an improvement of the existing energy-intensive and engineering-intensive aluminum piston designs and manufacturing methods. In this regards the instant invention goes against prior art practice of producing a single rough form, and relies upon making a multi-use piston blank that substantially overcomes the costly stages of the prior art, and fulfills these needs.

In the view of the foregoing disadvantages inherent in the known types of aluminum pistons and design and manufacturing methods present in the art, the present invention provides a new design and manufacturing method wherein the same can be utilized for producing a composite piston that reduces cost and wasted material to produce a lightweight, high-performance piston for competition or road use.

The invention provides a new method of designing and manufacturing composite pistons, wherein the method includes a process of forming chopped carbon ceramic material into a piston blank that is machinable to the end design of the given piston.

Another object of the present invention is to provide a design method for creating a composite piston in which one mold can be utilized to create a piston blank that accommodates a plurality of different piston end-designs, whereby the final design is machined from the singly designed blank.

An aspect of the invention described herein provides a method for designing and producing a composite piston having at least one or a plurality of piston designs, the method including: choosing at least one or the plurality of piston designs to obtain a piston blank design; forming a tooling cavity mold of the piston blank design and compression molding a carbon fiber reinforced epoxy molding compound composite material, a titanium material, and a high temperature resistant chopped carbon fiber reinforced composite material into a piston blank in the tooling cavity mold; and machining the piston blank into at least one or the plurality of piston designs.

In an embodiment of the method, forming tooling further includes: making a universal base tool for designing and producing the piston blank; designing specific parts including a cavity structure, a core component, and a core component guider to mold the piston blank; manufacturing the specific parts; and attaching the specific parts to the universal base tool to obtain the tooling cavity mold. In an embodiment of the method, compression molding further includes: inserting the high temperature resistant chopped carbon fiber reinforced composite material and the titanium material into the tooling mold; heating the carbon fiber reinforced epoxy molding compound composite material to obtain a heated composite material and inserting the heated composite material into the tooling mold; compressing the heated composite material, the high temperature resistant chopped carbon fiber reinforced composite material and the titanium material in the tooling mold; and cooling and removing the piston blank.

An embodiment of the method further includes machining at least one of: a pin bore of the piston, a first ring of the piston, a second ring of the piston, an oil ring of the piston, a weight savings along the pin bore of the piston, a diameter of the piston to final tolerance, and a dome of the piston. An embodiment of the method further includes after machining contacting the piston blank with an impregnating solution containing sodium silicate.

In an embodiment of the method, contacting the piston blank with the impregnating solution further includes: placing the piston blank into an autoclave; applying vacuum to the autoclave and subjecting the piston blank to negative autoclave pressure; heating the impregnating solution to obtain heated impregnating solution and introducing the heated impregnating solution into the autoclave; submerging the piston blank in the heated impregnating solution and increasing the autoclave pressure from negative pressure to positive pressure; maintaining positive pressure in the autoclave; removing the piston blank from the autoclave and washing the piston blank in cold water; and drying the piston blank.

In an embodiment of the method, the piston further includes at least one structure selected from: a pin bore, a first ring, a second ring, an oil ring, a weight saving along the pin bore, and a dome. In an embodiment of the method, the carbon fiber reinforced epoxy molding compound is Quantum Composites AMC 8593 HT. In an embodiment of the method, the high temperature resistant chopped carbon fiber reinforced composite is Cera Materials PC 70. In an embodiment of the method, the carbon fiber reinforced epoxy molding compound is a thermoset composite sheet molding compound.

An embodiment of the method further includes prior to inserting the chopped carbon fiber reinforced composite material and titanium material into the tooling mold: machining an angled undercut to the chopped carbon fiber reinforced composite material; and machining an undercut to the titanium material. In an embodiment of the method, inserting the chopped carbon fiber reinforced composite material and the titanium material further includes: placing a core component guider above the titanium material and chopped carbon fiber reinforced composite material; and bolting the core component guider to the cavity structure and maintaining tension of the temperature resistant chopped carbon fiber reinforced composite material and the titanium material during compression molding.

An aspect of the invention described herein provides a method of designing and producing a carbon fiber reinforced epoxy molding compound composite wrist pin button having at least one or a plurality of wrist pin button designs, the method including: choosing at least one or the plurality of wrist pin button designs to obtain a wrist pin button blank design; forming a tooling cavity mold of the wrist pin button blank design and compression molding a carbon fiber reinforced epoxy molding compound composite material to obtain a wrist pin button blank; coating the wrist pin button blank with an anti-friction coating; and machining the wrist pin button blank to obtain the wrist pin button; and sealing and impregnating the wrist pin button with a sodium silicate solution.

In an embodiment of the method, compression molding further includes: heating and inserting the carbon fiber reinforced epoxy molding compound composite material into the tooling mold; compressing the carbon fiber reinforced epoxy molding compound composite material in the mold; and cooling and removing the wrist pin button blank. In an embodiment of the method, sealing and impregnating the wrist pin button blank further includes: placing the wrist pin button blank into an autoclave; applying vacuum to the autoclave and subjecting the wrist pin button blank to negative autoclave pressure; heating the sodium silicate solution to obtain heated sodium silicate solution and introducing the heated sodium silicate solution into the autoclave; submerging the wrist pin button blank in the heated sodium silicate solution and increasing the autoclave pressure from negative pressure to positive pressure; maintaining positive pressure in the autoclave; removing the wrist pin button blank from the autoclave and washing the wrist pin button blank in cold water; and drying the wrist pin button blank.

In an embodiment of the method, the anti-friction coating is moly-disulfide. In an embodiment of the method, the carbon fiber reinforced epoxy molding compound composite material is Quantum Composite AMC 8593 HT.

An aspect of the invention described herein provides a method for designing and producing a tool mold for a piston blank having at least one or a plurality of piston designs, the method including: designing the piston blank by choosing the at least one or the plurality of piston designs, and making a universal base tool for the piston blank; designing and manufacturing specific parts including a cavity portion, a core construct, and a core construct guider to mold the piston blank; and attaching the specific parts to the universal base tool to obtain the tool mold for the piston blank.

An aspect of the invention described herein provides a titanium hybrid carbon composite piston blank including at least one or a plurality of piston designs. An embodiment of the piston blank includes at least three-components. An embodiment of the piston blank further includes at least one structure selected from: a crown, a first piston ring, a second piston ring, an oil ring, a pin bore, and a dome. An embodiment of the piston blank further includes a carbon fiber reinforced epoxy molding compound composite material component, a titanium component, and a high temperature resistant chopped carbon fiber reinforced composite component.

In an embodiment of the piston blank, the crown includes the high temperature resistant chopped carbon fiber reinforced composite component. In an embodiment of the piston blank, the first piston ring and the second piston ring include the titanium component. In an embodiment of the piston blank, the oil ring and the pin bore include the carbon fiber reinforced epoxy molding compound composite material component. An embodiment of the piston blank is impregnated with sodium silicate.

An aspect of the invention described herein provides a high-performance piston including a carbon fiber reinforced epoxy molding compound composite component, a titanium component, and a high temperature resistant chopped carbon fiber reinforced composite component and impregnated with sodium silicate.

An aspect of the invention described herein provides a wrist pin button blank having at least one or a plurality of wrist pin button designs and includes a carbon fiber reinforced epoxy molding compound composite. In an embodiment of the wrist pin button blank the composite is Quantum Composite AMC 8593 HT. An embodiment of the wrist pin button blank is coated with an anti-friction coating. An embodiment of the wrist pin button blank is impregnated with sodium silicate. An aspect of the invention described herein provides a wrist pin button including a carbon fiber reinforced epoxy molding compound composite.

An objective of the invention described herein provides a new method of designing and manufacturing composite pistons, in which the method includes processing carbon fiber reinforced epoxy molding compound composite material into a piston blank that is machinable to the end design of the given piston.

Another objective of the invention described herein is to provide a design method for creating a composite piston in which one tooling assembly is utilized to create a multitude of piston blank designs, and switching between different piston designs requires the minimal change in parts to accommodate a plurality of different piston end-designs, such that the final design is machined from the compression molded blank.

Other objects, features and advantages of the present invention becomes apparent from the following detailed description taken in conjunction with the accompanying drawings.

### BRIEF DESCRIPTION OF THE DRAWINGS

FIG. 1 is a schematic drawing of an isometric view for demonstrating winding filaments (1) around a mandrel (2).

FIG. 2 is a schematic drawing of an isometric view for demonstrating roll wrapping including: a mandrel (3), a woven laminate being wrapped around the mandrel (4), a 90-degree laminate being wrapped around the mandrel (5), a 45-degree laminate being wrapped around the mandrel (6), and a zero-degree laminate being wrapped around the mandrel (7).

FIG. 3 is a schematic drawing of a top view and a cross section view of a mold for a tube including: a molded part (8), a cavity (9), a core (10), a mandrel (11), the mandrel in the top view (12), and knife-edge areas of the core (13). The figure is for illustrative purposes only. The figure does not contain parts and features that typically exist in a functioning mold. The figure shows the core and cavity areas that interact with the molded part.

FIG. 4 is a schematic drawing of a top view and a cross section view of a mold design which does not contain knife-edge areas. The views include: the molded part (14), the cavity (15), the core (16), the mandrel (17), and the mandrel in the top view (18). The figure is for illustrative purposes only. The figure does not contain parts and features that typically exist in a functioning mold. The figure shows the core and cavity areas that interact with the molded part.

FIG. 5 is a schematic drawing of cross section views of molded parts that do not result in any knife-edge area, including: a rectangular cross section (19), a cross section with the parting line at the top (20), a cross section with the parting line between the center of the inner diameter and the top (21), a cross section with the parting line at the center of the inner diameter (22), a cross section with the parting line between the center of the inner diameter and the bottom (23), and a cross section with the parting line at the bottom (24).

FIG. 6 is a schematic drawing of a conceptual view of the pultrusion process, including: rovings of fiber (25), consolidation of the tows of fiber (26), a resin impregnation station (27), the resin (28), a heated die (29), a cooling die (30), pullers (31), a cutoff station (32), cutoff Fiber Reinforced Polymer (FRP) parts (33), and a catching station (34).

FIG. 7 is a schematic drawing of a conceptual view of the injection molding process, including: plastic pellets (35), a hopper (36), an injection ram (37), the pellets being pushed and heated (38), a heater (39), the sprue (40), the molded part (41), the cavity (42), the core (43), and cooling ports (44).

FIG. 8 is a schematic drawing of a front view, a cross section view, and an isometric view of an alternative compression molding process for molding a tube including: the molded part (45), the cavity (46), the mandrel (47), and the core (48). The figure is for illustrative purposes only. The figure does not contain parts and features that typically exist in a functioning mold. The figure shows the core and cavity areas that interact with the molded part.

FIG. 9 is a schematic drawing of a front view and cross section view of a piston, including: the dome area (49), the piston ring lands (50), the pin bore area (51), the skirt area (52), the outside diameter at the dome (53), the ring land thickness (54), the pin bore diameter (55), and the outside diameter at the skirt (56).

FIG. 10 is a schematic drawing of a top view and cross section view of three different types of pistons including: a flat domed piston (57), a dish domed piston (58), a protruding domed piston (59), the dome area of the flat domed piston (60), the dome area of the dish domed piston (61), the dome area of the protruding domed piston (62), the dome height of the flat domed piston (63), the dome height of the dish domed piston (64), and the dome height of the protruding domed piston (65).

FIG. 11 is a schematic drawing of a front view, cross section view, and isometric view of a one-piece contour compression molded piston blank (66).

FIG. 12 is a schematic drawing of a top view and cross section view of the molding process for a one-piece contour compression molded piston blank, including: the molded part (67), the cavity (68), the core (69), and the ejector pins (70). The figure is for illustrative purposes only. The figure does not contain parts and features that typically exist in a functioning mold. The figure shows the core and cavity areas that interact with the molded part.

FIG. 13 is a schematic drawing of an isometric view of an example winding jig for a piston blank, including: the winding (71), the winding jig base (72), winding jig protrusions that are attached to the base (73), winding jig protrusions that are the same piece as the base (74), and the ejector plate (75).

FIG. 14 is a schematic drawing of an isometric view of different fiber fabric reinforcement types, including a unidirectional fabric (76) and a plain weave woven fabric (77).

FIG. 15 is a schematic drawing of an exploded front view, isometric view, and cross section view of an exemplary layup jig in use, including: the bulk molding compound or sheet molding compound material (78), the windings (79), the fabric laminates (80), the base (81), and the removable cavity wall (82).

FIG. 16 is a schematic drawing of an exploded front view, isometric view, and cross section view of another exemplary layup jig in use, including: the bulk molding compound or sheet molding compound material (83), the windings (84), the fabric laminates (85), the base (86), and the ejector plate (87).

FIG. 17 is a schematic drawing of an isometric view of a conceptual, expanded view of the pre-molding process for a one-piece contour compression molded piston blank, including: the bulk molding compound or sheet molding compound material (88), the windings (89), the fabric fiber laminates (90), the cavity (91), and the core (92). The figure does not contain parts and features that typically exist in a functioning mold. The figure shows the core and cavity areas that interact with the molded part.

FIG. 18 is a schematic drawing of a top view and cross section view of the molding process for a one-piece injection molded piston blank, including: the molded part (93), the cavity (94), the core (95), the sprue (96), and the ejector pins (97). The figure is for illustrative purposes only. The figure does not contain parts and features that typically exist in a functioning mold. The figure shows the core and cavity areas that interact with the molded part.

FIG. 19 is a schematic drawing of an isometric view of a conceptual, expanded pre-molding process of an exemplary one-piece over mold injection molded piston blank, including: the windings (98), the fabric fiber laminates (99), the cavity (100), the core (101), and the sprue (102). The figure does not contain parts and features that typically exist in a functioning mold. The figure shows the core and cavity areas that interact with the molded part.

FIG. 20 is a schematic drawing of an isometric view of a conceptual, expanded pre-molding process for a one-piece resin injected and over molded piston blank, including: the chopped fiber (103), the windings (104), the fabric fiber laminates (105), the cavity (106), the core (107), and the sprue (108). The figure does not contain parts and features that typically exist in a functioning mold. The figure shows the core and cavity areas that interact with the molded part.

FIG. 21 is a schematic drawing of a front view, cross section view, and isometric view of a two-piece contour compression molded piston blank, including: the bottom body (109), the top body (110), a domed shape (111), a horizontal undercut (112), and angled undercuts (113).

FIG. 22 is a schematic drawing of a top view and cross section view of the molding process for a two-piece contour compression molded piston blank, including: the bottom body of the molded part (114), the top body of the molded part (115), the cavity (116), the core (117), and the ejector pins (118). The figure is for illustrative purposes only. The figure does not contain parts and features that typically exist in a functioning mold. The figure shows the core and cavity areas that interact with the molded part.

FIG. 23 is a schematic drawing of a top view and cross section view of the molding process for a two-piece injection molded piston blank, including: the bottom body (119), the top body (120), the cavity (121), the core (122), the sprue (123), and the ejector pins (124). The figure is for illustrative purposes only. The figure does not contain parts and features that typically exist in a functioning mold. The figure shows the core and cavity areas that interact with the molded part.

FIG. 24 is a schematic drawing of a front view and cross section view of a two-piece bonded piston blank, including: the bottom body (125), the top body (126), and a threaded bond (127).

FIG. 25 is a schematic drawing of a front view, cross section view, and isometric view of a three-piece contour compression molded piston blank, including: the bottom body (128), the middle body (129), the top body (130), a domed shape (131), a horizontal undercut in the middle body (132), a horizontal undercut in the top body (133), and angled undercuts (134).

FIG. 26 is a schematic drawing of a top view and cross section view of the molding process for a three-piece contour compression molded piston blank, including: the bottom body of the molded part (135), the middle body of the molded part (136), the top body of the molded part (137), the cavity (138), the core (139), and the ejector pins (140). The figure is for illustrative purposes only. The figure does not contain parts and features that typically exist in a functioning mold. The figure shows the core and cavity areas that interact with the molded part.

FIG. 27 is a schematic drawing of a top view and cross section view of the molding process for a three-piece injection molded piston blank, including: the bottom body (141), the middle body (142), the top body (143), the cavity (144), the core (145), the sprue (146), and the ejector pins (147). The figure is for illustrative purposes only. The figure does not contain parts and features that typically exist in a functioning mold. The figure shows the core and cavity areas that interact with the molded part.

FIG. 28 is a schematic drawing of a front view and cross section view of a three-piece bonded piston blank, including: the bottom body (148), the middle body (149), the top body (150), a threaded bond in the middle body (151), and a threaded bond in the top body (152).

FIG. 29 is a schematic drawing of isometric views of piston blanks demonstrating the machining process, including: an example three-piece contour compression molded piston body blank (153), an example three-piece bonded piston body blank (154), an example three-piece piston blank after machining (155), the machined outside diameter on the dome (156), the machined outside diameter on the skirt (157), the machined piston ring lands (158), the machined pin bore area (159), and the machined dome area (160).

FIG. 30 is a schematic drawing of a front view and cross section view of a three-piece composite piston blank with wrist pin inserts, including: the bottom body (161), the middle body (162), the top body (163), and the wrist pin inserts (164).

FIG. 31 is a schematic drawing of a front view, cross section view, and detailed view of a three-piece composite piston blank that has been coated on the dome and ring lands, including: the bottom body (165), the middle body (166), the top body (167), and the coating (168).

### DETAILED DESCRIPTION OF THE DISCLOSURE

The present application provides a new method for designing and producing fiber reinforced polymer pistons which are light weight having high strength, a low coefficient of thermal expansion, and a high service temperature. These qualities are desirable for pistons in high performance applications.

Technical ceramics are commonly considered advanced ceramics or engineered ceramics. Technical ceramics have desirable mechanical, thermal, and/or electrical properties. They are typically oxides, carbides, borides, nitrides, or silicides. Technical ceramics typically exhibit high hardness and substantially high compressive strengths. However, technical ceramics tend to be brittle and have substantially low tensile/shear strengths. Examples of technical ceramics are Al2O3 (Aluminum Oxide), SiC (Silicon Carbide), WC (Tungsten Carbide), Shapal (a hybrid aluminum nitride ceramic), Macor (a machinable glass-ceramic), BN (Boron Nitride), AlN (Aluminum Nitride), B4C (Boron Carbide), Si3N4 (Silicon Nitride), ZrO2 (Zirconium Oxide), TiN (Titanium Nitride), ZrN (Zirconium Nitride), CrN (Chromium Nitride), TiCN (Titanium Carbonotride), CrCN (Chromium Carbonotride), TiCrN (Titanium Chromium Nitride), AlTiN (Aluminum Titanium Nitride), and AlCrN (Aluminum Chromium Nitride).

Thermoplastics are polymers which are capable of being remelted and recast after being cooled. Examples of thermoplastics include polytetrafluoroethylene, polyvinylidene fluoride, polycarbonate, polyoxymethylene, nylon, polyamide-imide (polyamide-imides are thermoplastic or thermoset depending on the specific material), and polyether ether ketone.

Thermosets are polymers which are permanently cured by thermal or chemical activation. Examples of thermosets include polyester, epoxy, phenolic, vinyl ester, bismaleimide, polyurea, polyurethane, silicone, fluoropolymer, polyamide, and polyamide-imide (polyamide-imides are thermoplastic or thermoset depending on the specific material).

Fiber-Reinforced Polymer (FRP) is a composite material that consists of fibers embedded within a polymer matrix material (which is either a thermoplastic or thermoset resin). These composites generally have a substantially high strength-to-weight ratio and stiffness-to-weight ratio. Common examples of the fibers include carbon, boron, silica, quartz, fiberglass, aramid, Kevlar, and basalt.

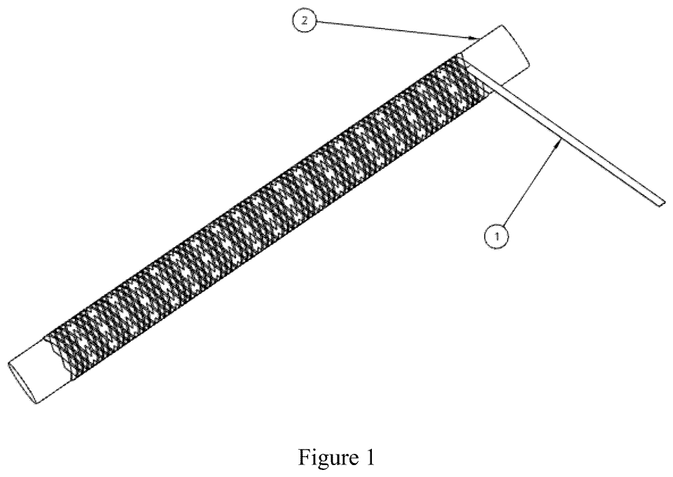

Filament Winding is a process in which tows of fiber that are under tension are fed through resin and wound around a rotating mandrel (which is generally made of steel). This process is illustrated in FIG. 1 having the mandrel (2) and the tow being wound around the mandrel (1). The winding creates geometric patterns which optimize strength in specific orientations. Fibers oriented in the zero-degree direction provide axial bending and compressive strength, fibers oriented in the 45-degree direction provide torquing strength, and fibers oriented in the 90-degree direction provide radial crushing strength. A piston experiences compressive forces, therefore, fiber orientations are generally in the 0-degree direction. Further, some fibers are oriented in other directions (45-degree and 90-degree) to mitigate radial resin expansion during compression. After winding, the mandrel/wound tow assembly is wrapped in a plastic wrap, heated, and cured. The plastic wrap contracts under heat, creating the necessary compaction in the part. The above process is commonly used to create a composite part, such that the mandrel is removed from the composite part and reused. In some embodiments, instead of using a removable/reusable steel mandrel, a composite part is used as the “mandrel”, and the filaments are permanent reinforcements that are stuck to the composite part, thereby using the filament winding provides additional support and strength to other FRP structures.

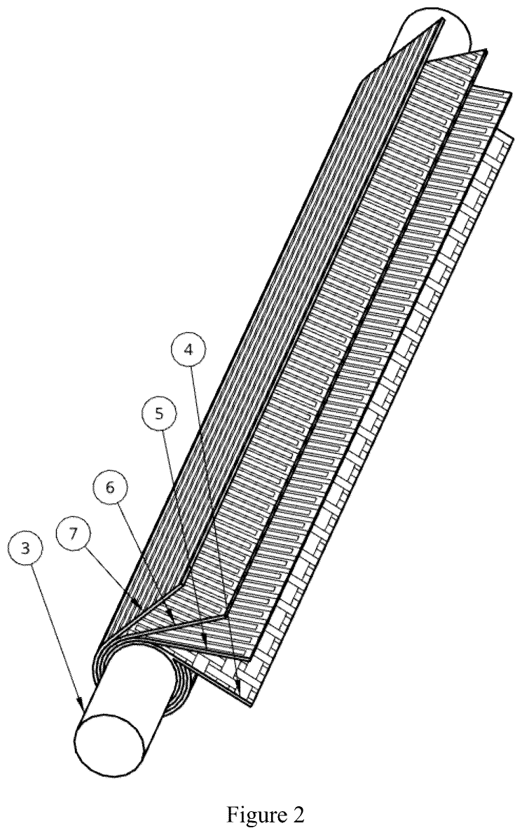

Roll Wrapping is a process in which layers of FRP laminates are wrapped on a mandrel (generally a steel mandrel) to create tubes. This process is illustrated in FIG. 2, in which the laminates are being wrapped around the mandrel (4, 5, 6, and 7). Different orientations and types of laminates are roll wrapped. For example, a woven laminate (4), a 90-degree laminate (5), a 45-degree laminate (6), and a zero-degree laminate (7). Similar to filament winding, fibers oriented in the zero-degree direction provide axial bending and compressive strength, fibers oriented in the 45-degree direction provide torquing strength, and fibers oriented in the 90-degree direction provide crushing strength. Fiber orientations in a piston generally are in the 0-degree direction to combat compressive forces and some fibers are oriented in other directions. Similar to the process of filament winding, the mandrel/laminate assembly is wrapped in plastic for compaction, heated, and cured. This process is commonly used to create a composite part with a reusable mandrel. However, in some embodiments, other FRP structures act as the “mandrel” and the wrapped laminates acts as additional support, strength, and permanent reinforcements to the wrapped FRP structure.

Compression Molding is a process used to produce parts, in which FRP material is placed into a mold and compressed under pressure with a press. After a set amount of time, the pressure is released, the mold is opened, and the part is ejected. If the FRP material is thermoset based, the material is optionally preheated before molding and the temperature of the mold must be hot enough to cure the material. However, if the material is thermoplastic based, it must be preheated to a temperature above its glass transition temperature (Tg) to allow the material to soften enough for molding. The mold temperature is optimally set below the melting temperature (Tm) of the material such that the part is ejected quickly. However, for thermoplastic compression molding, the mold temperature sometimes must be set above Tm for the material to adequately fill the mold cavity. For thermoplastic compression molding, the mold must be cooled to a temperature less than Tm before ejection, thereby adding cycle time and costs. Generally, the FRP material used in compression molding consists of a bulk molding compound (BMC) or sheet molding compound (SMC) with discontinuous chopped fiber. BMCs are generally processed in bulk form and are not pre-formed before molding. However, SMCs are processed into a sheet before molding, such that SMCs typically have a lower compression ratio (the ratio between the volume of material before molding and the volume of material after molding). If continuous fiber laminates are used with compression molding, extra attention and time is needed to ensure that the laminates are placed in their exact position and that the fibers are orientated in the correct direction.

Contour Compression Molding is a method of compression molding a near net shape of the final part geometry. The contour compression molded part may require additional steps, such as post-molding machining, to reach the final geometry of the part. However, most profile features from the contour compression molded part are generally not altered after molding.

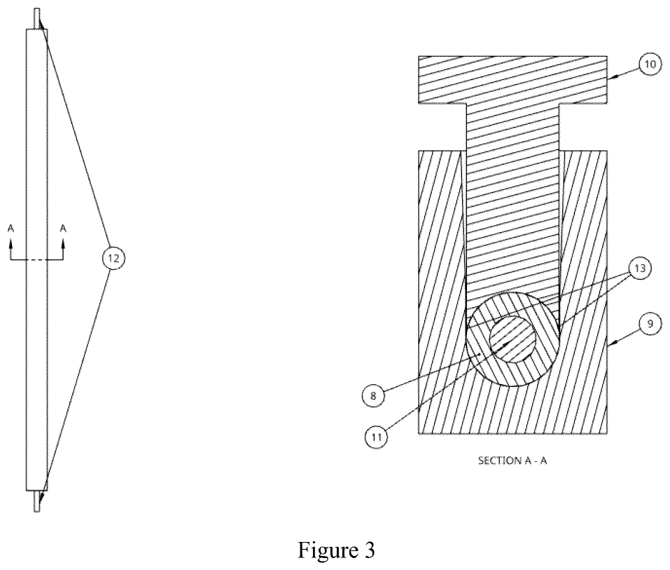

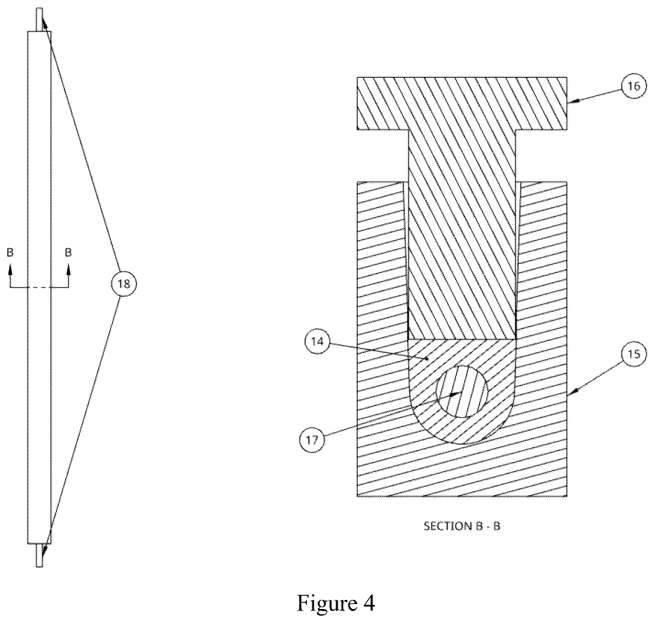

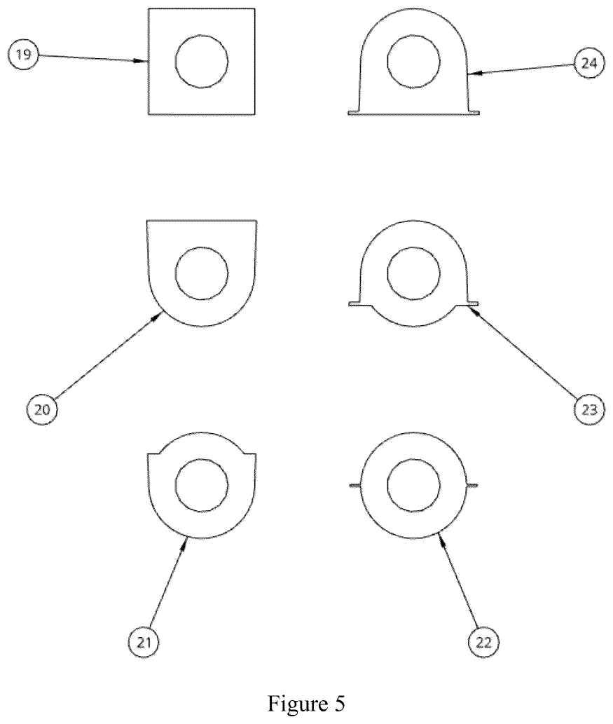

Compression Molding a Tube: A tube shape cannot be compression molded directly as shown in FIG. 3 because the core of the mold (10) creates very thin knife-edge areas (13). These knife-edge areas are almost zero thickness and hence would break upon machining the mold. Further, even if the knife-edge areas do not break during machining, they would break off due to the high pressures that are experienced during molding by the cavity and core surfaces. Therefore, to compression mold a tube, a molded part that does not create a knife-edge area has to be molded first. As seen in FIG. 4, the molded part (14) is flat at the top at the parting line between the cavity (15) and the core (16) thereby obtaining a compression molded tube without any knife-edge areas. FIG. 5 illustrates exemplary cross sections for molding a tube without creating knife edge areas such as: a rectangular cross section (19), a cross section having the parting line at the top (20), a cross section having the parting line between the center of the inner diameter and the top (21), a cross section having the parting line at the center of the inner diameter (22), a cross section having the parting line between the center of the inner diameter and the bottom (23), and a cross section having the parting line at the bottom (24). In the cross section having the parting line at the center of the inner diameter (22), the flange on either side is removed by handwork. Tubes compression molded by the other designs (19, 20, 21, 23, and 24) require secondary machining after molding to create the outer, circular profile of the tube. Therefore, in some embodiments, compression molding a tube includes an additional step of creating the outer profile of the tube by handwork or machining. To create the internal hole of the tube, a mandrel must be inserted as seen in FIG. 3 and FIG. 4, in which the mandrel (11, 12, 17 and 18) is inserted into the cavity of the mold before the molding material is inserted. After inserting the mandrel, the molding material is inserted, and the mold is closed under pressure for a set time. The mold is then opened, the mandrel is removed from the mold, and the part is ejected. The mandrel is reusable.

Compression Molding a Rod: The process for compression molding a rod is similar to compression molding a tube. However, for a rod a mandrel is not used, resulting in a solid molded part without a tubular cavity. Similar to the process of compression molding a tube, compression molding a rod requires an additional step of creating the outer profile of the rod by handwork or machining.

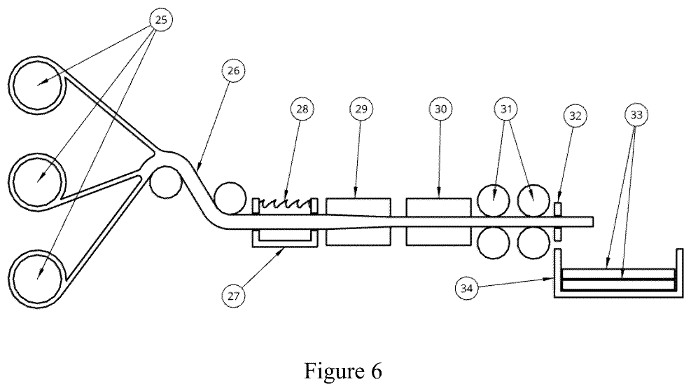

Pultrusion is a process used to produce continuous fiber-reinforced polymers with a constant cross section. In some embodiments, the FRP being pultruded is shaped as a rod or a tube. The process of pultrusion is illustrated in FIG. 6. Tows from the rovings of fiber reinforcements are pulled and consolidated (25 and 26) and fed into a resin impregnation station (27), in which the fiber reinforcement is impregnated with a thermoset or thermoplastic resin (28). The resin-impregnated fiber is then pulled through a heated shaping die (29), which for a rod or a tube would be either an open hole for creating the outer diameter of a rod profile or an open hole with a mandrel for creating the internal diameter of a tube. If the FRP is thermoset based, the heated pultrusion die causes the resin to cure and solidify. If the FRP is thermoplastic based, the heated pultrusion die is used to fuse the different impregnated fiber tows together, and a cooling die (30) is used to solidify the FRP. The solidified FRP is then clamped and pulled out by pullers (31). The solidified FRP is then cut at the right length with saws at the cutoff station (32). The cutoff FRP parts (33) then fall into a catching station (34).

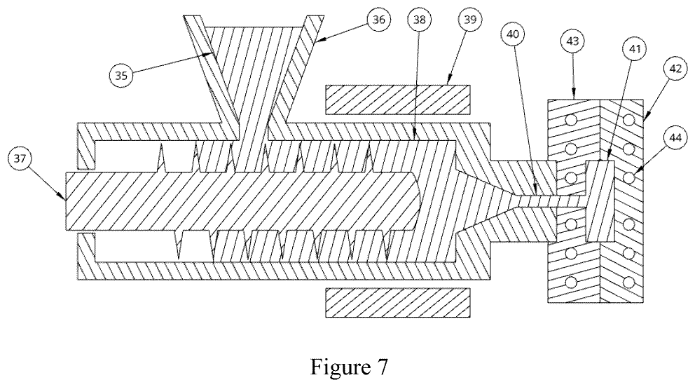

Injection molding is a process used to produce molded products, in which plastic material is injected into a mold, solidified, and ejected. The process of injection molding thermoplastic materials is illustrated in FIG. 7. Pellets of plastic material (35) are inserted into a hopper (36). An injection ram (37), which generally has the shape of a screw, turns to push the plastic forward. The plastic being pushed forward (38) is heated by heaters (39) and pushed through the sprue (40), which is a narrow opening for the plastic to flow through. The plastic is molded into the shape of the molded part (41) by being injected into the cavity (42) and the core (43). In thermoplastic injection molding, cooling ports (44) which typically run water are present to solidify the part before the cavity (42) and core (43) are separated and the part is ejected. In thermoset injection molding, there are no heaters (39), and the plastic material (35) is inserted cold, into the heated cavity (42) and core (43). Further, instead of cooling ports (44), thermoset injection molding includes heaters. The heaters in the cavity (42) and core (43) of the mold cure the thermoset material coming from the sprue (40) and solidify the part before ejection. The thermoset or thermoplastic material being injected is generally an unreinforced polymer. Pellets with fiber reinforcement are used to injection mold FRP material. However, it is generally difficult to achieve long fiber lengths because the fibers break in the process of getting pushed by the injection ram (37) and through the sprue (40).

Over mold injection molding is a variant of injection molding in which the cavity of the mold is preloaded with material before the plastic material is injected. Over mold injection molding is used to add other materials, such as metals, technical ceramics, or FRPs, to the final part. Because the plastic material coming from the sprue is injected at high pressures and the other materials preloaded into the cavity have undercuts, over mold injection molding creates strong bonds.

Resin injection molding is a variant of injection molding in which the cavity of the mold is preloaded with dry fiber material before the plastic material is injected. Resin injection molding generally creates stronger parts compared to standard injection molding because resin injection molding allows for long fibers to be preloaded into the mold before the resin is injected. In some embodiments, resin injection molding is built over mold injection molding, in which other materials, such as metals, technical ceramics, or FRPs, are inserted into the mold with the dry fiber material before the plastic is injected.

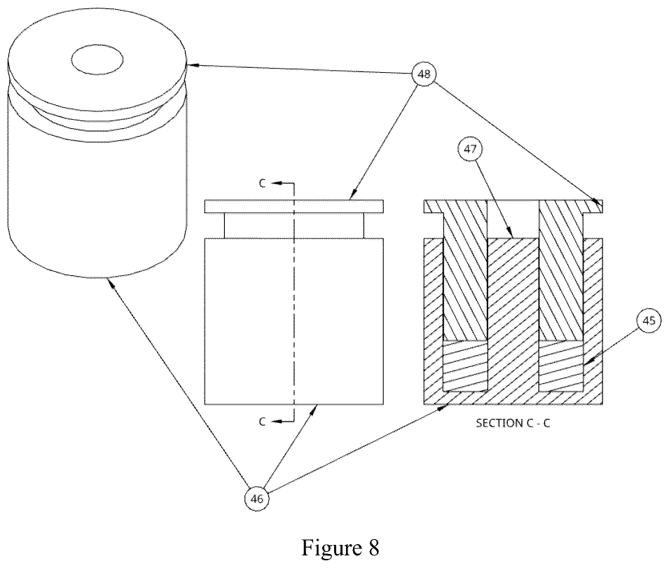

Vertically Compression Molding a Tube: A tube shape is compression molded in an alternative method as illustrated in FIG. 8, in which the molded part (45) is molded between the cavity (46) and core (48). The mandrel (47) is vertical, and oriented in the direction of the cavity and core compression. The mandrel (47) and the cavity (46) are the same pieces or alternatively the mandrel (47) is attached to the cavity (46) by fasteners as a pin. This process is typically used on tubes that have a relatively low length-to-diameter ratio.

Vertically Compression Molding a Rod: The process for vertically compression molding a rod is similar to vertically compression molding a tube. However, for a rod a mandrel is not used, resulting in a solid molded part without a tubular cavity.

Sodium Silicate Solution is a solution of silica and sodium oxide dissolved in water. The sodium silicate has a weight ratio of 3.22 (SiO2:Na2O), which breaks down as about 28.7% silica (SiO2) to about 8.9% sodium oxide (Na2O) resulting in a solution which is approximately 37.5% sodium silicate by weight in water.

Sodium Silicate Impregnation is a process that introduces Sodium Silicate as a filling material into the open pores of the material being treated. The process eliminates or greatly reduces the undesirable hygroscopic effects of porosity in the parts being treated. Parts being impregnated are first treated with a sodium silicate solution containing both potassium dichromate, and chromic acid(s). The solution fills the porosity of the parts, and the parts are then thoroughly washed in cold water, thereby leaving the solution in the pores of the substrate. The parts are placed in the autoclave to remove the air from the pores by applying vacuum for a specific period of time, usually about 20 minutes at 26″Hg. A heated sodium silicate solution is introduced into the vacuum autoclave, the parts are covered with the solution and pressure is applied to increase from negative pressure to positive pressure. The standard temperature is maintained at about 95° C. to 100° C. and the pressure is about 60 lbs. to 85 lbs. per square inch. The pressure is maintained for about 8 hours and then released. The parts are subsequently removed from the autoclave and solution, then thoroughly washed in cold water. The parts are then placed into a low temperature oven at about 100° C. for at least one hour. The specific gravity of the Sodium Silicate Solution used is maintained by addition of water intermittently as the solution tends to evaporate upon heating to operating temperatures.

Heavy Metal Ion Implantation (HMII) is a process that bombards heavy metal ion particles, such as but not limited to Uranium, Molybdenum, Titanium, Tungsten, or Chromium, deep into the molecular structure of part surfaces. The process of HMII increases the microhardness of the surface and fatigue life of the part. In addition, the implantation treatment creates a surface finish which is smoother compared to typical industrial processes, such as lapping or vibratory finishing. The heavy metal ions are typically accelerated to about 400 miles per second before colliding with the part being treated. The process typically occurs in a vacuum of 1 billionth atmospheric pressure to prevent contamination from air molecules or any disruption of the path for the heavy metal ions to flow. Because the bombarding ions add energy to the substrate, and heat cannot dissipate well in vacuum, parts being treated typically need a heat soak system to prevent the temperature of the substrate from rising above their glass transition temperature.

Vapor Deposited Coating is a process that applies high-performance solid material coatings onto a given substrate. The two main processes are Physical Vapor Deposition (PVD) and Chemical Vapor Deposition (CVD). In PVD, the material to be coated is vaporized and condensed into a thin film on the substrate being coated, either by sputtering or evaporation. In CVD, the substrate being coated is exposed to volatile precursors that react on the surface of the substrate to produce the desired deposit. The following list of coatings is exemplary only and not intended to be limiting. DLC (Diamond-Like Carbon) is a coating that consists of diamonds suspended in a graphite matrix. The coating has a hardness of about 1600 to about 2000 Hv and a coefficient of friction of 0.05-0.10. A higher concentration of diamonds increases both the hardness and the coefficient of friction. MoS2 (Molybdenum Disulfide) is a very thin anti-friction coating that reflects the hardness of the substrate underneath. The coating generally has a 0.01-0.03 coefficient of friction and is typically applied directly to the substrate or to a hard ceramic coating. TiN (Titanium Nitride), ZrN (Zirconium Nitride), CrN (Chromium Nitride), TiCN (Titanium Carbonotride), CrCN (Chromium Carbonotride), TiCrN (Titanium Chromium Nitride), AlTiN (Aluminum Titanium Nitride), and AlCrN (Aluminum Chromium Nitride) are hard technical ceramic coatings that have a hardness of over 2000 Hv. These coatings are generally followed by a coating of MoS2 because of their high coefficient of friction. Aluminum, brass, cadmium, chromium, copper, gold, iron, molybdenum, nickel, silver, titanium, and zinc are example metal coatings. These coatings are generally used to create a conductive surface that can be built up with electroplating.

Electroplating is a process that uses controlled electrolysis (using electric current to cause a non-spontaneous chemical reaction) to apply a desired metal coating from an anode to a cathode. Examples of metals that are electroplated include aluminum, brass, cadmium, chromium, copper, gold, iron, molybdenum, nickel, silver, titanium, and zinc. The anode is the metal part which is used to create the plating, and the cathode is the part being coated by the anode material. Both the anode and cathode are placed in a bath with electrolyte chemicals and are exposed to an electric charge. The electric charge causes anions (negatively charged ions) to move to the anode and cations (positively charged ions) to move to the cathode, which covers the cathode part in a metal coating. This creates a thin shell of metal on the cathode part. To electroplate non-conductive substrates, such as most FRP materials, the parts must first be made electrically conductive. This is typically achieved by adding a thin Layer of metal through an electroless plating process, such as PVD coating. For the embodiments described herein, electroplating FRP material includes an optional initial step of electroless plating to manufacture a conductive surface as appropriate for adding an electroconductive layer.

Plasma Spray Coating is a process where a substrate is sprayed with molten or semi-molten material to create a hard coating. The coatings are applied in a high temperature process in which the powdered coating material is heated through an extremely hot plasma flame (over 15,000° F.) and accelerated toward the substrate. The coating material then cools and forms a hard coating. Plasma spray coatings are generally used to protect the substrate from oxidization, to create a thermal barrier coating, to create an anti-friction surface, and/or to create an anti-wear surface. Generally, for plasma spray coating FRP materials, the materials are pre-coated with a bond coat such as nickel-aluminide. The bond material provides a more conductive and harder surface which enables bonding with a secondary coat. For embodiments described herein, plasma spray coating FRP material includes an optional initial step of applying a bond coat to manufacture a conductive and harder surface as appropriate for adding a conductive surface.

Dry Film Coatings create anti-friction surfaces that maintain a low coefficient of friction even under dry conditions (without liquids or oils). Molybdenum Disulfide (MoS2), Tungsten Disulfide (WS2), and graphite are common dry film coatings. Dry film coatings are typically applied by brushing, spraying, or dipping, in which the dry film coating material (MoS2, WS2, or graphite) is added to resins and binders that are then coated on the part. These resins and binders typically require either a thermal, chemical, or air cure. Dry film coatings are also applied by impingement coating, in which the coating is applied in an extremely thin layer and does not require a cure.

Turning is a machining process in which material is removed from a rotating workpiece by a cutting tool. This process is typically performed on a lathe and allows for the creation of high precision, and rotationally symmetric parts.

Thermoset Adhesives are adhesives made from a thermoset resin. These adhesives are supplied in a pre-cured state, applied to the workpiece for bonding and cured. Some adhesives cure chemically, in which exposure to air or a chemical reactor (in which the adhesive would normally consist of two components that are mixed before being applied) effects curing. Some adhesives cure thermally, in which heat is used to cure the adhesive. Common examples of thermosetting adhesives are JB Weld and Loctite.

Thermoplastic Adhesives are adhesives made from a thermoplastic resin. Thermoplastic adhesives typically consist of resins that are preheated to near or above their melting temperature before they are applied to the workpiece. The workpiece is bonded, and the resin is then allowed to cool and harden. Thermoplastic adhesives are commonly based on Ethylene Vinyl Acetate (EVA).

Standard FRP Billet Rods are rods made from FRP material and are then machined into further shapes. A Standard FRP Billet Rod is manufactured by any of the following methods which are exemplary only and not intended as further limiting.

Resin Transfer Molding (RTM) a Standard FRP Billet Rod: In this process, dry fibers are placed into a mold, which is then filled with resin and usually heated to help the resin cure. Conventional RTM typically occurs at pressures less than 40 bar. This process directly molds rod shapes. However, RTM includes creating a sheet and then machining rod shapes from the sheet.

High Pressure Resin Transfer Molding (HPRTM) a Standard FRP Billet Rod: In this process, unlike conventional RTM which uses pressures less than 40 bar, HPRTM uses pressures of up to 200 bar during the molding process to greatly increase efficiency with cycle times as short as a few minutes for smaller parts. Further, during the HPRTM process, the mold is typically a closed mold which is not fully compressed when the resin is injected thereby allowing excess resin to flow in the mold. The mold is then compressed with a press to squeeze out the excess resin, allowing for higher molding efficiencies, higher fiber-to-resin ratios, and better mechanical properties compared to conventional RTM. This process directly molds rod shapes. However, HPRTM includes creating a sheet and then machining rod shapes from the sheet.

Vacuum Assisted Resin Transfer Molding (VARTM) a Standard FRP Billet Rod: This is a method of creating FRP parts in which dry fibers are placed into a mold, similar to the mold used in RTM. In VARTM, the resin flow is assisted by a vacuum. An advantage of VARTM is having cheaper equipment costs and high fiber-to-resin ratios compared to conventional RTM. This process directly molds rod shapes. This process also includes using VARTM to create a sheet and then machining rod shapes from the sheet.

Compression Molding a Standard FRP Billet Rod: This is a method of creating FRP parts in which material is placed into a mold, compressed, and ejected. This process directly molds rod shapes, as described in both methods of the definition section. This process includes using compression molding to create a sheet and then machining rod shapes from the sheet.

Pultruding a Standard FRP Billet Rod: This is a method of creating FRP parts with a constant cross section in which tows of fiber are consolidated, impregnated with resin, solidified, and then cut. This process directly molds rod cross sections. This process also includes using pultrusion to create a sheet and then machining rod shapes from the sheet.

Injection Molding a Standard FRP Billet Rod: This is a method of creating FRP parts in which material is injected into a mold, solidified, and ejected. This process directly molds rod shapes. The process includes using injection molding to create a sheet and then machining rod shapes from the sheet.

Vacuum Bagging a Standard FRP Billet Rod: This is a method of creating FRP parts in which the material is placed on a mold tool, covered with a ply (which is used to improve the surface finish), and covered with a breather fabric which absorbs extra resin. The system is then placed in a vacuum bag, which is used to remove the air and mold the part. Vacuum bagging removes excess air and humidity during the curing process thereby allowing a high fiber-to-resin ratio, increasing the mechanical properties, and decreasing the impurities of the FRP part. In addition, the process of vacuum bagging typically utilizes very low setup and tooling costs. This process directly molds rod shapes. The process also includes using vacuum bagging to create a sheet and then machining rod shapes from the sheet.

Hand Laying Up a Standard FRP Billet Rod: This is a method of creating FRP parts in which fibers, that are unidirectional, woven, knitted, stitched, chopped, or bonded, are placed in a mold, and reinforced with resin by a brush. Among the various methods described herein, this process typically has the lowest setup and tooling costs. However, the process is very labor intensive and often produces parts that need to be scrapped. This process directly molds rod shapes. The process also includes using hand layups to create a sheet and then machining rod shapes from the sheet.

Autoclave Manufacturing a Standard FRP Billet Rod: This is a method of creating FRP parts in which plies of FRP are placed in a mold and spot-welded together, then vacuum bagged and placed in an autoclave. The plies are then subjected to high pressure and temperatures to cure. This process directly molds rod shapes. The process also includes using autoclave manufacturing to create a sheet and then machining rod shapes from the sheet.

Roll Wrapping a Standard FRP Billet Rod: This is a method of creating FRP Billet Rods in which one of the above methods described herein (RTM, HPRTM, VARTM, Compression Molding, Pultrusion, Injection Molding, Vacuum Bagging, Hand Laying Up, or Autoclave Manufacturing) is used to create a billet rod core. After the core is created, it is roll wrapped with FRP laminates, with the core functioning as a “mandrel,” and roll wrapping is used to reinforce another FRP part.

Filament Winding a Standard FRP Billet Rod: This is a method of creating FRP Billet Rods in which one of the above methods described herein (RTM, HPRTM, VARTM, Compression Molding, Pultrusion, Injection Molding, Vacuum Bagging, Hand Laying Up, or Autoclave Manufacturing) is used to create a billet rod core. After the core is created, the core is filament wound with FRP tows. The core functions as the “mandrel,” and the filament winding is used to reinforce another FRP part.

Utilizing a combination of Roll Wrapping and Filament Winding on a Standard FRP Billet Rod: This is a method of creating FRP Billet Rods in which one of the above methods described herein (RTM, HPRTM, VARTM, Compression Molding, Pultrusion, Injection Molding, Vacuum Bagging, Hand Laying Up, or Autoclave Manufacturing) is used to create a billet rod core. After the core is created, it is either filament wound with FRP tows and then roll wrapped with FRP laminates, or roll wrapped with FRP laminates and then filament wound with FRP tows. Carbon-Carbon materials are composites which include a graphite matrix that is reinforced with carbon fiber. These materials have exceptionally high service temperatures, excellent thermal shock resistance, and an extremely low coefficient of thermal expansion. Carbon-carbon is generally manufactured by laying up carbon filaments in a plastic that is sufficiently heated to induce pyrolysis. Pyrolysis transforms the organic binder to pure carbon. However, as the binder loses volume, voids are formed which are then filled with high pressure and high heat by a carbon-forming gas. Due to the large amount of energy and labor necessary in the manufacturing process, carbon-carbon materials are very expensive.

Parts of a Piston:

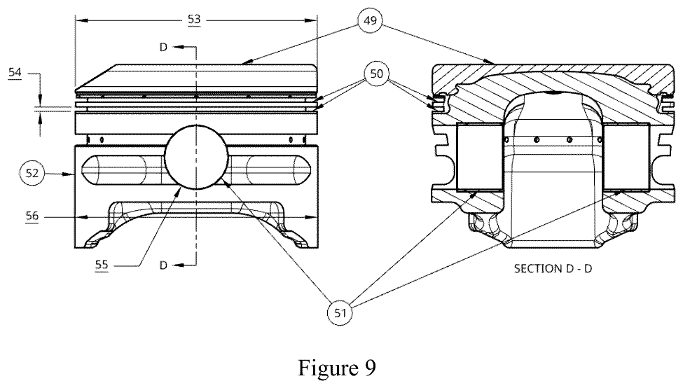

FIG. 9 contains view of the different standard areas or parts of a piston, namely the dome area (49), the piston ring lands (50), the pin bore area (51), the skirt area (52), the outside diameter at the dome (53), the ring land thickness (54), the pin bore diameter (55), and the outside diameter at the skirt (56).

The dome area (49) is the area of the piston that directly interacts with the gases within the combustion chamber of the engine. The difference between the outside diameter at the dome (53) and the internal diameter of the bore of the engine determines the piston-to-bore clearance. The piston-to-bore clearance determines the amount of the exhaust gases that flow down the side of the piston and reach other areas, such as the rings. Therefore, the outside diameter of the dome is a key dimension of the piston.

The piston ring lands (50) hold the rings of the pistons. An adequate ring thickness to ring land thickness clearance is required to allow the rings to be inserted into the piston without much friction. Further, too much clearance Leads to a sloppy fit, such that the tolerance on the ring land thickness (54) has to be held very tight. Therefore, the ring land thickness (54) is an important dimension of the piston.

The pin bore area (51) is the area of the piston which directly interacts with the wrist pin. The wrist pin connects the piston to the connecting rod and further to the crankshaft. Because of the amount of force from combustion which pushes the piston on the wrist pin, the pin bore diameter (55) is a critical dimension of the piston as it determines the wrist pin clearance. A tight wrist pin clearance results in friction as parts bend from the immense pressures of an engine. A large wrist pin clearance results in a sloppy fit, resulting in a “hammering effect” every time the piston goes up and down. Therefore, the tolerance on the pin bore diameter (55) must be held tight.

The skirt area (52) is the area on which the piston slides on the engine cylinders. The outside diameter at the skirt (56) is a key dimension because the difference between the outside diameter at the skirt and the internal diameter of the bore of the engine determines the skirt-to-bore clearance. The skirt-to-bore clearance is normally smaller than the piston-to-bore clearance, such that the skirt-to-bore clearance determines the fit of the piston (either loose or tight) within the bore. If the skirt-to-bore clearance is too large, then the piston may rock back and forth. If the skirt-to-bore clearance is too tight, then the piston may seize in the cylinder. Therefore, the tolerance on the outside diameter at the skirt (56) has to be held very tight.

Piston Dome Area Explanation:

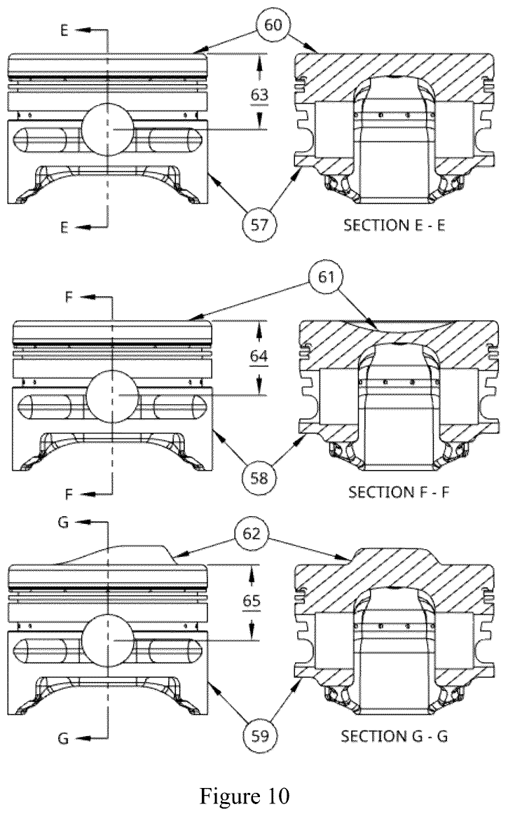

There are three types of piston domes illustrated in FIG. 10, which shows a flat domed piston (57), a dish domed piston (58), a protruding domed piston (59), the dome area of the flat domed piston (60), the dome area of the dish domed piston (61), and the dome area of the protruding domed piston (62).

As illustrated in FIG. 10, a flat domed piston has a relatively flat top, a dish domed piston has a depressed top, and a protruding domed piston has a bulged top. Dish domed pistons are used to add space and increase the volume of the combustion chamber. Protruding domed pistons are used to occupy space in the combustion chamber and decrease the volume of the combustion chamber. Therefore, the compression ratio (the ratio of volume of the air-fuel mixture before the compression stroke to the volume of the air-fuel mixture after the compression stroke) is decreased or increased by using a dish domed piston or protruding domed piston, respectively.

The dome height of the piston is the measurement from the center of the pin bore to the flat top of the piston dome. FIG. 10 illustrates the dome height of the flat domed piston (63), the dome height of the dish domed piston (64), and the dome height of the protruding domed piston (65). The dome height is not inclusive of the protruding part or dished part of the dome (FIG. 10).

To reduce the complexity and length, drawings of flat domed pistons are illustrated herein. However, embodiments of the invention described herein include flat domed, dish domed, and protruding domed pistons.

Fiber Reinforced Polymer (FRP) Pistons:

FRP pistons are beneficial for the engine because using FRP pistons results in quicker and easier acceleration (which leads to higher fuel efficiency and reduced greenhouse gas emissions), better powertrain stability, less wear on other components, a reduction in harmful powertrain harmonics, and greater thermal efficiency (which also contributes to higher fuel efficiency and reduced greenhouse gas emissions).

FRP pistons have the same overall strength at a significantly lower weight compared to aluminum pistons. For example, a replacement FRP piston in some applications is more than 40% lighter than an existing aluminum piston. The weight of the piston varies based on the engine and the application. Aluminum pistons for aftermarket racing applications range from about 400 to 1,000 grams. Composite pistons for aftermarket racing applications range from about 200 to 700 grams. Composite pistons are generally from about 10% to about 50% or from about 20% to about 60% or from about 30% to about 70% or from about 40% to about 80% lighter than incumbent aluminum pistons. The reduction in weight allows for much quicker and easier acceleration because much less energy is spent by the engine to accelerate the linear movement of the pistons. The quicker and easier acceleration results in an engine that expends less fuel to achieve the same speed, thereby reducing greenhouse gas emissions. The reduced weight also results in better powertrain stability because less mass has to be accelerated and decelerated every time the crankshaft rotates, reducing the momentum of the powertrain. The reduction in momentum reduces the force and stress on other components, such as the wrist pins, connecting rods, and crankshafts. The reduction in force and stress reduces wear and increases the part life of these other components. Further, because FRP is a different material than the metal powertrain parts which are in contact with the FRP piston, the FRP piston has a different resonance frequency and stops the harmful harmonic effects experienced in a metal only powertrain.

By using materials with high service temperatures in the dome of a piston, the FRP pistons are also generally capable of withstanding much higher temperatures than achievable with aluminum alloys. The increased service temperature allows for the air-fuel ratio in an engine to be increased, as increasing the air-fuel ratio leads to higher combustion temperatures. The higher air-fuel ratio allows for increased thermal efficiency, as the fuel is more thoroughly burnt.

The actual temperature of combustion is over 3,000° F. which is greater than the melting temperature of aluminum. The actual temperature that the piston experiences is lower than the temperature of combustion because the entire heat in the combustion chamber heat is not absorbed by the pistons. The piston is exposed to the combustion temperature for a miniscule duration of the four-stroke cycle. The high-grade aluminum alloys in the pistons become soft at a temperature of over 300° F., and at this temperature the stresses from combustion break the aluminum. The mechanical properties of aluminum are typically degraded by up to 60% at temperature over 300° F. Therefore, the actual temperature the piston experiences is not more than 300° F. for aluminum piston.

The composite materials have a service temperature of at least about 400° F. for a phenolic and at least about 650° F. for a polyimide. Carbon-carbon composite materials have service temperatures of about 2,000° F. to about 4,000° F.

The CTE (coefficient of thermal expansion) of the FRP material used in the dome of the pistons is generally significantly smaller than the CTE of aluminum alloys. The reduction in the CTE of the dome material allows FRP pistons to run a much tighter piston-to-bore clearance, as the pistons expand upon heating. Therefore, lesser the combustion gases leak down the side walls of the pistons, thereby resulting in a greater thermal efficiency as less energy from the combustion is diverted to heating up areas below the piston dome.

The thermal conductivity of the FRP material used in the dome of the pistons is generally significantly smaller than the thermal conductivity of aluminum alloys. In addition, if a thermal barrier coating is used on the pistons, then the thermal conductivity is reduced even more. The reduction in thermal conductivity reduces the amount of heat that is absorbed by the dome of the piston, which results in greater thermal efficiency because a lower amount of the energy from the heated gases is used to heat soak the piston.

These three characteristics of an FRP piston (a greater air-fuel ratio, a tighter piston-to-bore clearance, and a reduced thermal conductivity) greatly increases the thermal efficiency of an engine. Therefore, higher fuel efficiency is achieved as more power is generated with less fuel, greatly reducing greenhouse gas emissions.

The first step to manufacturing fiber-reinforced polymer pistons is to identify the technical parameter of the pistons to be produced. This includes identifying the general critical or key or essential technical dimensions (as defined in “Piston Terminology”) and finding the dome geometry.

After identifying the dimensions of the pistons to be produced, piston body blanks are manufactured. The piston body blanks are either one-piece, two-piece, or three-piece components that consist of at least 50% FRP (by volume). After the piston body blanks are manufactured, secondary processes are used to turn the piston body blanks into the final pistons.

Manufacturing One-Piece Piston Body Blanks:

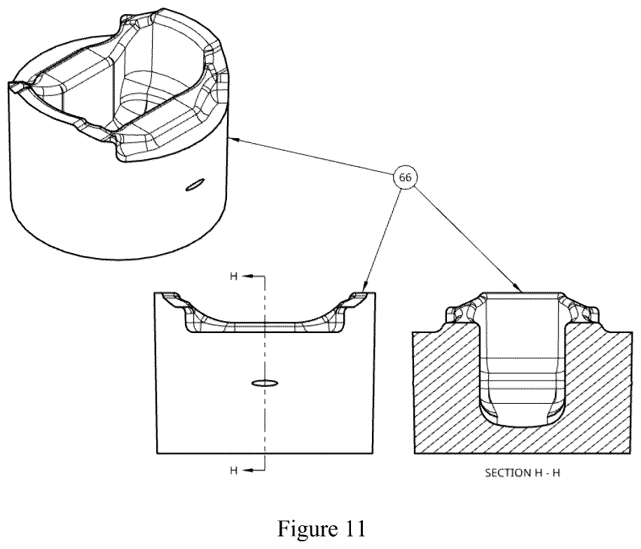

A one-piece piston body blank is manufactured with contour compression molding. The molded part is illustrated in FIG. 11, which shows a one-piece contour compression molded piston blank (66).

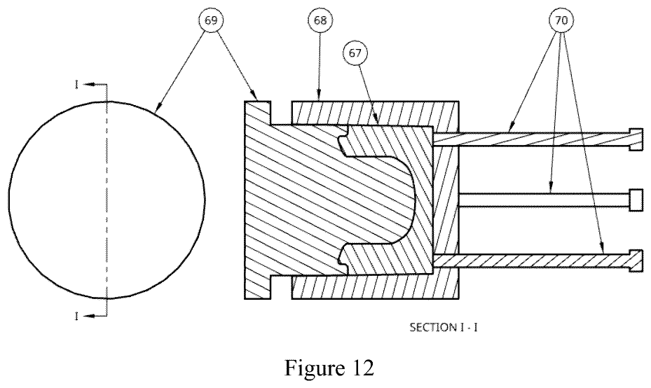

The standard molding process for creating a one-piece piston body blank is shown in FIG. 12. The molded part (67) is compression molded from Bulk Molding Compounds (BMC) or Sheet Molding Compounds (SMC) between the cavity (68) and the core (69). After the BMC or SMC material is solidified, the one-piece piston body blank is ejected by the ejector pins of the mold (70).

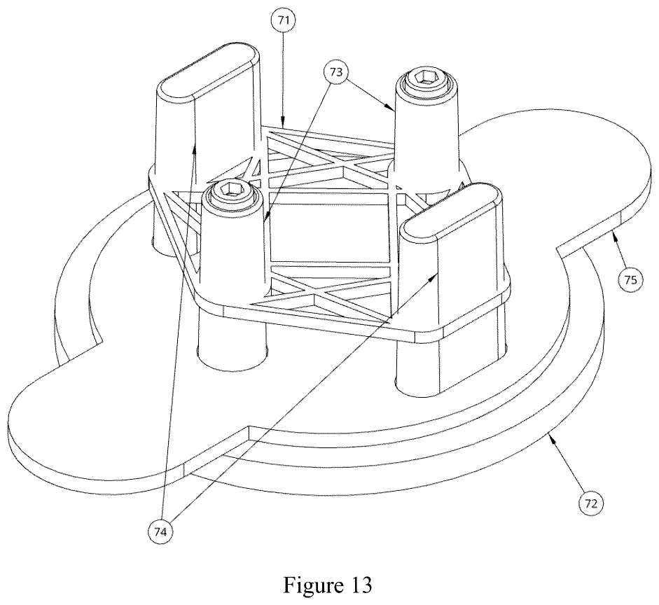

FRP windings add reinforcement to the molded one-piece piston body blank. The process of making the windings is illustrated in FIG. 13. The winding (71) consists of FRP tows which are wound on a winding jig. The winding jig base (72) has winding jig protrusions that are attached to the base (73) and/or winding jig protrusions that are the same piece as the base (74). These winding jig protrusions that are the same piece as the base (74) are generally machined into the base (72) as one part. The winding (71) is wound on these different winding jig protrusions in any order, and in any thickness as seen necessary by the manufacturer. After the winding (71) is made on the winding jig, an ejector plate (75) is used to push the winding off the winding jig.

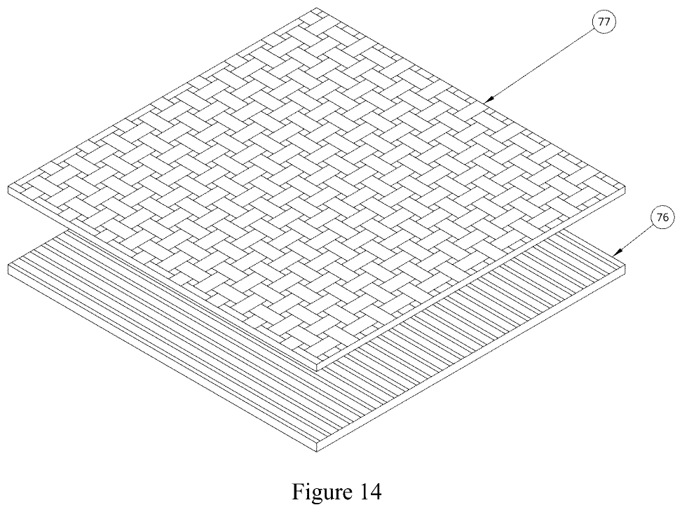

In alternative embodiments, FRP fabric laminates are used to add reinforcement to the molded one-piece piston body blank. Fabric laminates are illustrated in FIG. 14, with a unidirectional fabric laminate (76) and a plain weave woven fabric laminate (77). Although not illustrated in FIG. 14, any type of fabric weaves, such as twill-weaves, satin-weaves, etc. are suitable for fabric laminates.

FRP windings and/or FRP fabric laminates are used as reinforcement in high-performance applications. In some applications, the chopped fiber FRP material alone is not strong enough to withstand the extreme forces placed on a piston. It is generally a rare instance because high-performance chopped fiber FRP materials have mechanical properties greater than those of aerospace grade aluminum alloys. However, future innovations may lead to greater cylinder pressures, necessitating the use of additional reinforcements to the chopped fiber to increase mechanical properties. A more common usage of these additional reinforcements is in applications in which a manufacturer wants to reduce the weight of the pistons as much as possible. The added reinforcements increase the strength-to-weight ratio of the pistons, allowing a manufacturer to attain similar or increased piston strength at a reduced weight.

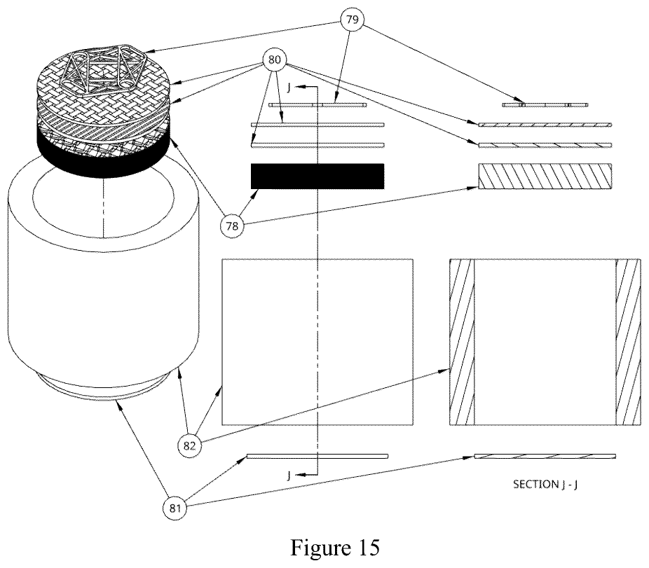

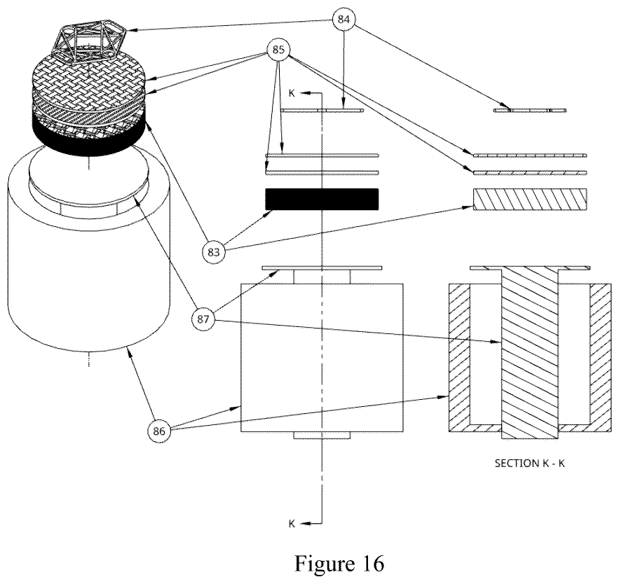

Before compression molding the BMC or SMC, and/or adding the FRP windings and/or FRP fabric laminates, a layup jig is used to prepare the molded shot. For example, layup jigs are illustrated in FIG. 15 and FIG. 16. The layup jig generally holds the BMC or SMC material (78 and 83), the added FRP windings (79 and 84), and the added FRP fabric laminates (80 and 85) together for preheating. In both thermoset and thermoplastic based materials, preheating the material to be molded together helps to create a stronger part, while also reducing cycle time. This reduction in cycle time in turn reduces manufacturing costs. If the material is thermoplastic based, although optional, it is highly recommended to use a layup jig. Without preheating, the thermoplastic material is hard, and the mold will have to first be heated and then cooled to create the molded part. For thermoset materials, it is recommended to use a layup jig, however it is not necessary because thermoset molding material is generally sufficiently soft to be molded while uncured. In addition, thermoset material cannot be preheated for too long, as doing so causes the molding material to cure within the layup jig.

If using a layup jig, after all the molding material is preheated together, it is inserted into the cavity of the mold. To make the material easily transferable to the mold, the layup jig has to either allow easy access to the molding material or have an ejector system. The layup jig illustrated in FIG. 15 allows for easy access to the molding material, because a base (81) lies within a removable cavity wall (82). The removable cavity wall (82) is pulled up, exposing the molding material. The layup jig in FIG. 16 uses an ejector system, because of the presence of a base (86) and an ejector plate (87). The base (86) and the ejector plate (87) are placed upside down on top of the mold, and the ejector plate (87) is pressed down to push the molding material into the cavity of the mold.

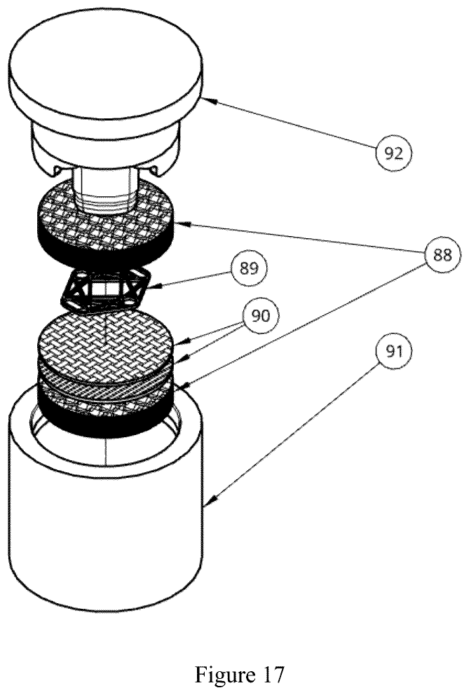

FIG. 17 illustrates a conceptual, expanded view of the pre-molding process in which FRP windings and FRP fabric laminates are added. The BMC or SMC material (88), the FRP windings (89), and the FRP fabric laminates (90) are inserted into the cavity (91) of the mold. Then, the core (92) closes to mold these materials together. If FRP windings and/or FRP fabric laminates are being used, the high cavity pressures result in good adhesion and bonding between the different molding materials.

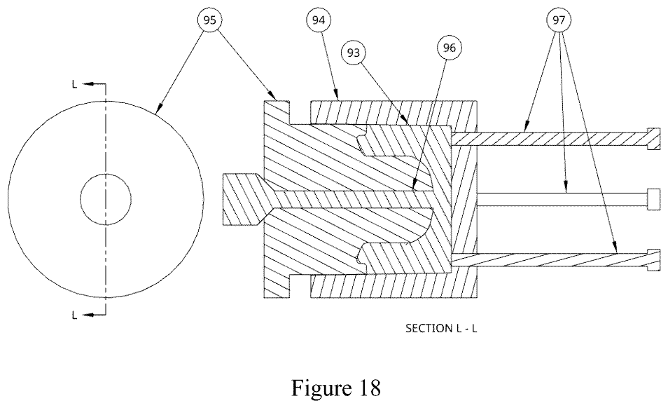

A one-piece piston body blank is manufactured with injection molding. The standard injection molding process for creating a one-piece piston body blank is illustrated in FIG. 18. The one-piece injection molded piston body blank would have the same or very similar geometry to the contour compression molded piston body blank. The molded part (93) is injection molded out of an FRP material between the cavity (94) and the core (95). The FRP material is injected through the sprue (96) and after the FRP material is solidified, the one-piece piston body blank is ejected by the ejector pins (97).

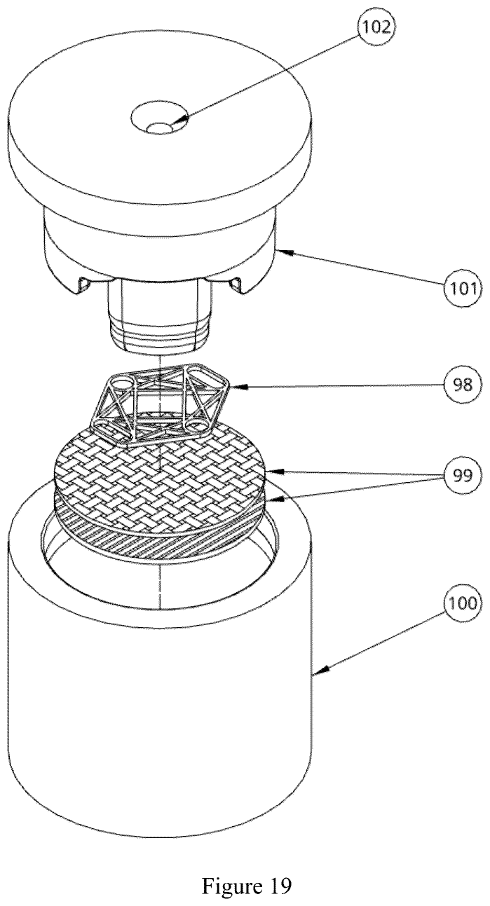

Over mold injection molding is also used to add FRP windings and/or FRP fabric laminates to the one-piece piston blank. FIG. 19 illustrates a conceptual, expanded view of the pre-molding process for over mold injection molding with added FRP windings and FRP fabric laminates. The FRP windings (98) and the FRP fabric laminates (99) are inserted into the cavity of the mold (100). The core of the mold (101) then closes on the mold, and FRP material is injected through the sprue (102). The FRP windings and FRP fabric laminates are either inserted dry (without any resin) or inserted wet (with resin impregnated). If the windings and/or fabric material are inserted dry, the injected FRP material has a lower fiber-to-resin ratio so that more of the resin impregnates the winding and/or fabric reinforcement material.

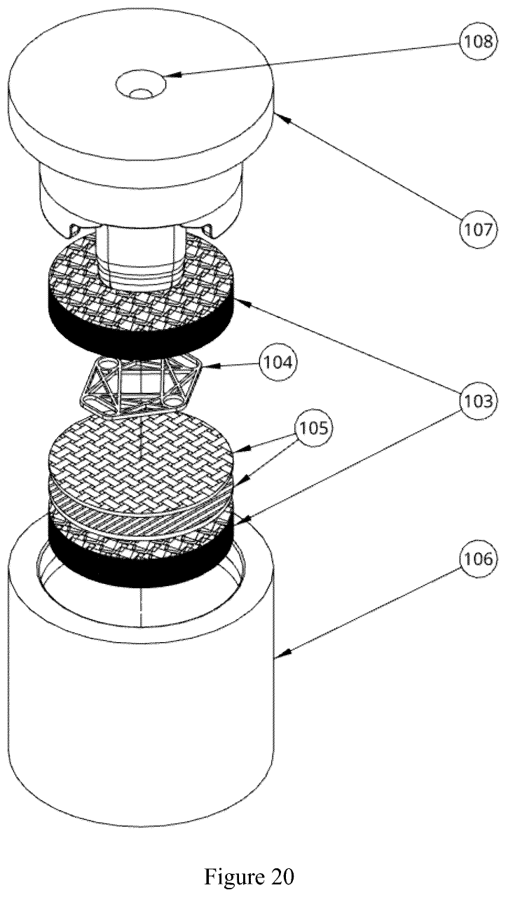

Resin injection molding is also used for creating the one-piece piston blank. FIG. 20 illustrates a conceptual, expanded view of the pre-molding process for a resin injected and over molded one-piece piston blank with added FRP windings and FRP fabric laminates. The chopped fiber (103), the FRP windings (104), and the FRP fabric laminates (105) are inserted into the cavity of the mold (106). The core of the mold (107) then closes on the mold, and resin is injected through the sprue (108). The chopped fiber, FRP windings, and FRP fabric laminates are generally inserted dry so that no significant cavity pressure is raised until the resin is injected, as the volume of the resin is not added to the part before the resin is injected.

Similar to the characteristics of product made by compression molding, adding FRP windings or FRP fabric laminates as reinforcements and the high pressures from the injection pressures with injection molding result in combining the different molding materials together and good adhesion is a more certain outcome. To contour compression mold or injection mold a one-piece piston blank that has a dished or protruding dome, the dome profile may be part of the cavity of the mold, requiring less secondary processing to create the dome profile.

A one-piece piston blank is also produced by any type of standard FRP Billet Rod.

Manufacturing Two-Piece Piston Body Blanks:

A two-piece piston body blank is used in applications in which the manufacturer wants to use a different material in the dome of the piston compared to the main body of the piston because materials that have a low density, high mechanical properties, and high service temperatures are generally very expensive. Therefore, the material costs of using a very expensive material in the dome is reduced by creating a two-piece piston body blank, as most of the piston is made from less expensive FRP material. In other cases, the dome material may have the requisite thermal properties but may have a relatively high density. Therefore, to save weight the manufacturer uses the heavy material only in the dome of the piston.

The top body is made from standard FRP Billet Rod material, a carbon-carbon material, a technical ceramic, or metal. The bottom body is an FRP material, either contour compression molded, injection molded, or made from a standard FRP Billet rod.

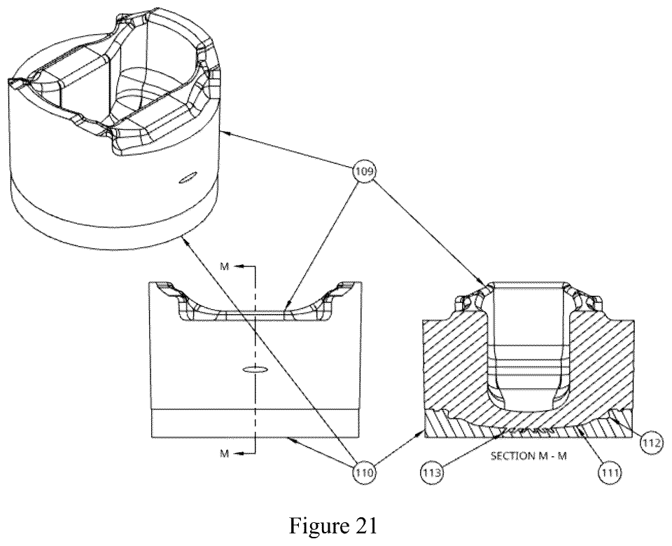

A two-piece piston body blank is manufactured with contour compression molding. The molded part is illustrated in FIG. 21, which shows the bottom body (109) and the top body (110). The two parts are typically bonded together with horizontal undercuts (112), angled undercuts (113), or a combination of both. In addition, a domed shape (111) is normally used to increase the mechanical properties of the final part.

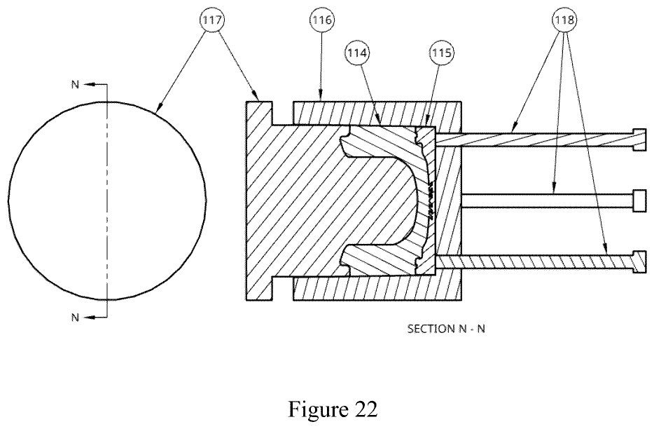

The standard molding process for creating a two-piece piston body blank is illustrated in FIG. 22. The bottom body (114) is compression molded from a BMC or SMC and molded with the top body (115) between the cavity (116) and core (117). After the BMC or SMC material is solidified into the shape of the bottom body (114), the two-piece piston body blank is ejected by the ejector pins of the mold (118).

FRP windings and/or FRP fabric laminates are added as reinforcements to the molded two-piece piston body blanks as described herein for the method for manufacturing the one-piece piston body blank. The FRP windings and/or FRP fabric laminates are inserted into the cavity with the BMC or SMC material, and the material is compression molded with the top body.

Further, a layup jig is used to prepare the mold before compression molding as described herein for the method for manufacturing the one-piece piston body blank. While using the layup jig for the two-piece piston body blank, the top body is placed into the layup jig with the molding material. The layup jig either allows easy access to the molding material or has an ejector system.

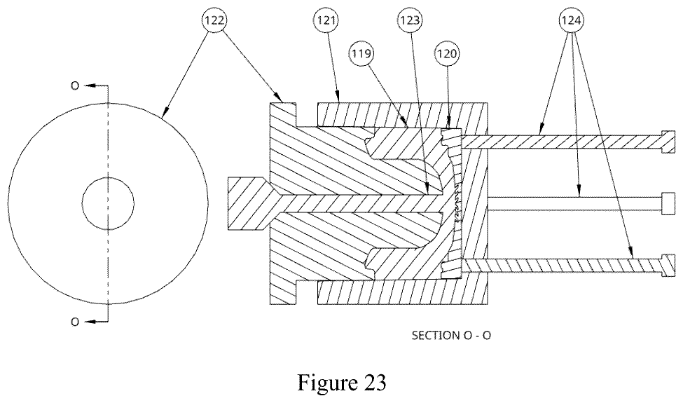

A two-piece piston body blank is also manufactured with injection molding as described herein for the manufacturing process of the one-piece piston body blank. The standard injection molding process for creating a two-piece piston body blank is illustrated in FIG. 23. As with the one-piece piston body blank, the two-piece injection molded piston body blank has the same or similar geometry compared to the contour compression molded piston body blank. The bottom body (119) is an FRP that is over mold injection molded with the top body (120) between the cavity (121) and the core (122). The FRP material is injected through the sprue (123) and forms the bottom body (119). After the FRP material is solidified, the two-piece piston body blank is ejected by the ejector pins (124).

FRP windings and/or FRP fabric laminates are added as reinforcements to the injection molded two-piece piston body blanks with over mold injection molding by the methods described herein for manufacturing the one-piece piston body blank. In this process, the FRP windings and/or FRP fabric laminates are inserted into the cavity dry or wet with the top body, the core closes, and FRP material is then injection molded.

Alternatively, resin injection molding are used for the two-piece piston body blank. In this process, dry chopped fiber is inserted into the cavity with the top body, the core closes, and resin is injected. In some embodiments, dry FRP windings and/or dry FRP fabric laminates are inserted with the chopped fiber and top body for additional reinforcement.

Contour compression mold or injection mold for a two-piece piston body blank that has a dished or protruding dome is achieved by the method described herein for manufacturing the one-piece piston body blank. Accordingly, as the dome profile is part of the cavity of the mold, less secondary processing is required to create the dome profile.

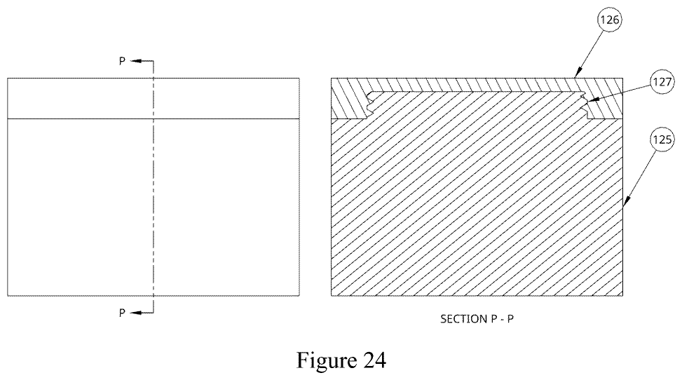

A two-piece piston body blank is also made by bonding to create a bonded two-piece piston body blank. The bottom body consists of a standard FRP Billet rod that is machined into shape. An example bonded two-piece piston body blank is illustrated in FIG. 24, with the bottom body (125) bonded to the top body (126). The bottom body and top body are bonded with either a thermoset or thermoplastic adhesive. An optional threaded bond (127) is included to increase the strength of the bond between the parts.

Manufacturing Three-Piece Piston Body Blanks:

A three-piece piston body blank is used in applications in which a two-piece piston body blank is used. The third piece (the middle body) is typically added to serve as the ring land area and is typically easy to machine.

The top body and middle body of a three-piece piston body blank are made from a standard FRP Billet Rod material, a carbon-carbon material, a technical ceramic, or a metal. The bottom body is an FRP material, being either contour compression molded, injection molded, or made from a standard FRP Billet rod.

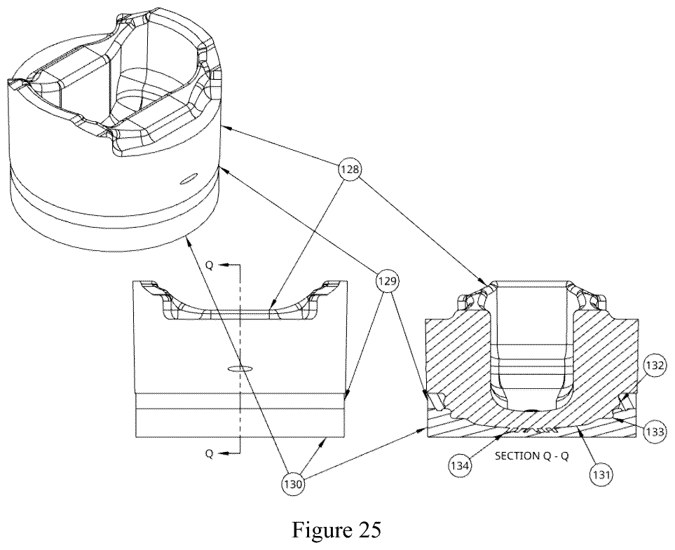

A three-piece piston body blank is manufactured with contour compression molding. The molded part is illustrated in FIG. 25, which shows the bottom body (128), the middle body (129), and the top body (130). The middle body (129) is bonded to the bottom body (128) with a horizontal undercut in the middle body (132). The top body (130) is bonded to the bottom body (128) with horizontal undercuts (133), angled undercuts (134), or a combination of both. A domed shape (131) between the bottom body (128) and top body (130) is generally used to increase the mechanical properties of the final part.

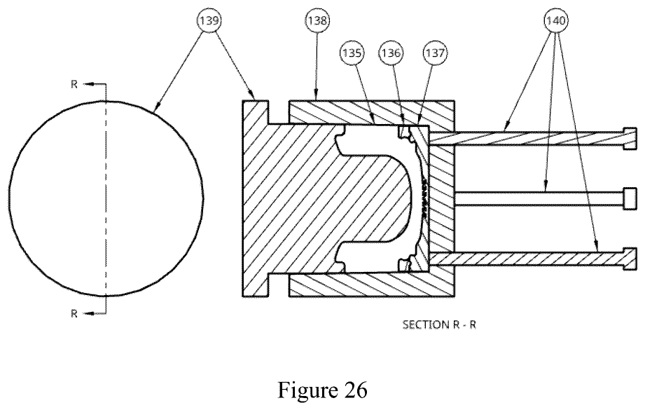

The standard molding process for creating a three-piece piston body blank is illustrated in FIG. 26. The bottom body (135) is compression molded from a BMC or a SMC and molded with the middle body (136) and top body (137) between the cavity (138) and core (139). After the BMC or SMC material is solidified into the shape of the bottom body (135), the three-piece piston body blank is ejected by the ejector pins of the mold (140).

FRP windings and/or FRP fabric laminates are added as reinforcements to the molded three-piece piston body blanks as described herein for the method for manufacturing the one-piece piston body blank. The FRP windings and/or FRP fabric laminates are inserted into the cavity with the BMC or SMC material, and the material is compression molded with the middle and top body.

A layup jig is used to prepare the mold before compression molding as described herein for the method for manufacturing the one-piece piston body blank. The middle and/or top body are placed into the layup jig with the molding material. The layup jig either allows easy access to the molding material or has an ejector system.

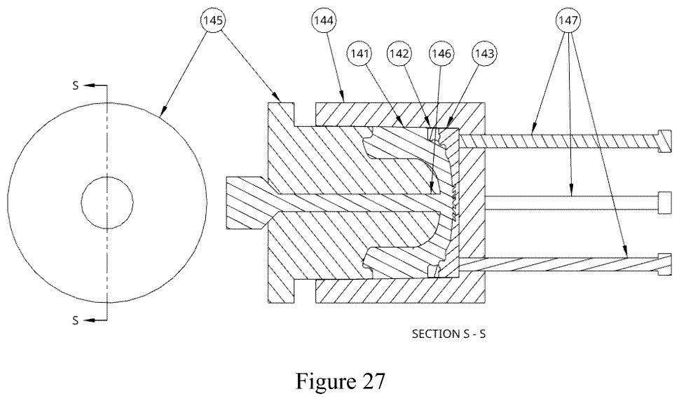

A three-piece piston body blank is manufactured with injection molding as described herein for the method for manufacturing the one-piece piston body blank. The standard injection molding process for creating a three-piece piston body blank is illustrated in FIG. 27. The three-piece injection molded piston body blank has the same or similar geometry to the contour compression molded piston body blank as described herein for the manufacture of the one-piece piston body blank. The bottom body (141) is an FRP that is over mold injection molded with the middle body (142) and the top body (143) between the cavity (144) and the core (145). The FRP material is injected through the sprue (146) and forms the bottom body (141). After the FRP material is solidified, the three-piece piston body blank is ejected by the ejector pins (147).

FRP windings and/or FRP fabric laminates are added as reinforcements to the injection molded three-piece piston body blanks with over mold injection molding as described herein for the manufacturing process of the one-piece piston body blank. In this process, the FRP windings and/or FRP fabric laminates are inserted into the cavity dry or wet with the middle body and top body, the core closes, and FRP material is then injection molded.

Alternatively, resin injection molding is used for the three-piece piston body blank. In this process, dry chopped fiber is inserted into the cavity with the middle body and top body, the core closes, and resin is injected. Dry FRP windings and/or dry FRP fabric laminates are also inserted with the chopped fiber, middle body, and top body for additional reinforcement.

Contour compression mold or injection mold a three-piece piston body blank that has a dished or protruding dome is achieved by the method as described herein for manufacturing the one-piece piston body blank, the dome profile may be part of the cavity of the mold, requiring less secondary processing to create the dome profile.

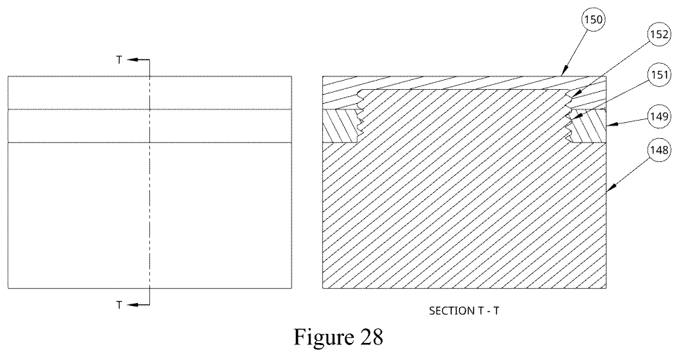

A three-piece piston body blank is also made through bonding to create a bonded three-piece piston body blank. The bottom body consists of a standard FRP Billet rod that is machined into shape. An example bonded three-piece piston body blank is illustrated in FIG. 28, with the bottom body (148) bonded to the middle body (149) and the top body (150). The bottom body, middle body, and top body are bonded with either a thermoset or thermoplastic adhesive. Optional threaded bonds (151 and 152) between the bottom body (148), middle body (149), and top body (150) increase the strength of the bond between the parts. The bottom body may also be bonded to the middle body, with the middle body bonded to the top body.

Secondary Processes:

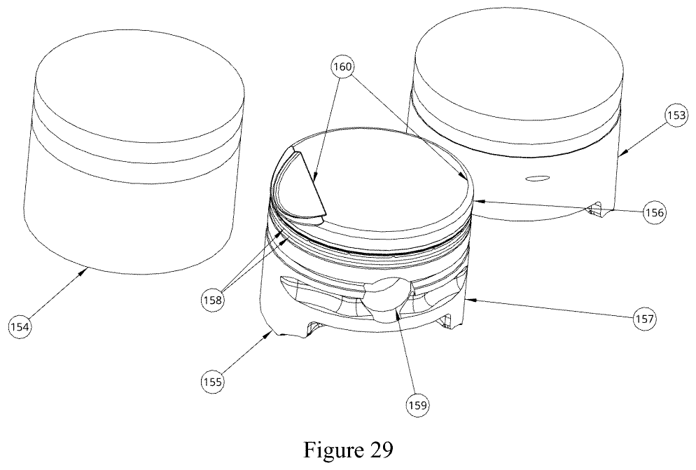

After creating the piston body blanks, critical areas or integral parts of the piston body blanks are machined to create piston blanks. This machining step is illustrated in FIG. 29. An example three-piece contour compression molded piston body blank (153) and three-piece bonded piston body blank (154) are shown. An example three-piece piston blank after machining (155) is shown. Notable areas that are typically machined in this step include the machined outside diameter on the dome (156), the machined outside diameter on the skirt (157), the machined piston ring lands (158), the machined pin bore (159), and the machined dome area (160). The machining is typically performed by turning, milling, or grinding.

Machining a one-piece standard FRP billet rod blank, a two-piece bonded piston body blank, or a three-piece bonded piston body blank typically removes much more material than machining a contour compression molded or injection molded piston body blank. Major profiles have to be machined from the rod shapes, while these profiles are generally molded in with contour compression or injection molding. Therefore, in higher quantities, contour compression molding or injection molding is typically more cost efficient as less machining is required.

A bearing surface for the pin bore must be created. The pin bore surface must have a 0-32 microinch Ra finish. However, a 0-8 microinch Ra finish is far more desirable.

Creating the bearing surface is performed by directly machining the pin bore into the composite body. After machining the pin bore, honing is typically used to achieve the necessary surface finish and pin bore dimension. However, in some embodiments any permutation or combination of the following finishing processes is used: honing, grinding, turning, lapping, polishing, vibratory finishing, or electropolishing. If the surface is directly machined into the composite body, a coating is normally required to create a good bearing surface. If a coating is applied after the pin bore is machined into the piston blank, the finishing process occurs after the coating is applied.

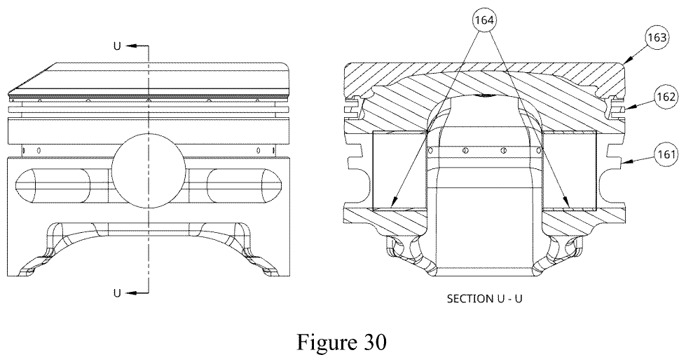

Creating the bearing surface is performed by using a wrist pin insert. The wrist pin insert is made from a metal or technical ceramic (FIG. 30). FIG. 30 illustrates a three-piece composite piston blank with a bottom body (161), a middle body (162), and a top body (163). Wrist pin inserts (164) are bonded inside the bottom body (161) with thermoset or thermoplastic adhesives. The wrist pin inserts have their bore dimension and surface finished before bonding, but it is preferable to leave extra stock on the internal diameter of the wrist pin inserts so that the two wrist pin inserts can be honed together after being bonded to the piston. The process of finishing the wrist pin inserts together after bonding guarantees that a wrist pin can fit into the piston properly. While honing is typically used to achieve the necessary surface finish and pin bore dimension on the wrist pin inserts (either before or after bonding), in some embodiments any permutation or combination of the following finishing processes is used: honing, grinding, turning, lapping, polishing, vibratory finishing, or electropolishing. If a coating is applied after the wrist pin inserts are bonded to the piston blank, the finishing process occurs after the coating is applied.

A vapor deposited coating is optionally applied onto the piston blanks. The vapor deposited coating is used to protect the piston blanks from oxidization, to create an anti-friction surface, and/or to create an anti-wear surface. Typically, Zirconium Nitride (ZrN) is used because ZrN provides a hard surface and also creates a good bonding surface if Zirconium Oxide (ZrO2) is plasma spray coated on after PVD coating. The coating is from any of the following: DLC, MoS2, any technical ceramic (such as but not limited to TiN, ZrN, CrN, TiCN, CrCN, TICrN, AlTiN, or AlCrN), any metal (such as but not limited to aluminum, brass, cadmium, chromium, copper, gold, iron, molybdenum, nickel, silver, titanium, or zinc), and a combination of MoS2 on any technical ceramic (such as but not limited to TiN, ZrN, CrN, TiCN, CrCN, TICrN, AlTiN, or AlCrN) or any metal (such as but not limited to aluminum, brass, cadmium, chromium, copper, gold, iron, molybdenum, nickel, silver, titanium, or zinc). The vapor deposited coating is applied over the entire piston. Alternatively, a combination of specific integral areas or parts of the piston are coated (such as the outside diameter, the pin bore, the ring lands, and/or the dome).

The piston blanks are optionally electroplated with a metal (such as but not limited to aluminum, brass, cadmium, chromium, copper, gold, iron, molybdenum, nickel, silver, titanium, or zinc) to protect them from oxidization, to create an anti-friction surface, and/or to create an anti-wear surface. Because FRP material is generally not electrically conductive, an initial conductive coating is generally applied in an electroless plating process before electroplating. Similar to applying a vapor deposited coating, the entire piston blank is electroplated, or a combination of specific critical areas or integral parts or key areas are electroplated (such as the outside diameter, the pin bore, the ring lands, and/or the dome).

The pistons blanks are also optionally plasma spray coated to protect the piston from oxidization, to create a thermal barrier coating, to create an anti-friction surface, and/or to create an anti-wear surface. Typically, Yttria stabilized Zirconium Dioxide (YSZ) is applied on the dome areas and ring lands, as YSZ has phenomenal thermal barrier properties, has good anti-wear properties, and effectively stops the piston blanks from oxidizing upon exposure to combustion gases. Pure molybdenum or MoS2 is typically applied on the outer diameter or pin bore to create a good bearing/anti-friction surface. The coating is selected from any of the following: a technical ceramic (such as but not limited to Zirconia, Yttria, Aluminum Oxide, Chromium Oxide, Mullite, Spinel, Titania, Tungsten Carbide, or Chromium Carbide), a metal (such as but not limited to aluminum, brass, cadmium, chromium, copper, gold, iron, molybdenum, nickel, silver, titanium, or zinc), or a combination of pure molybdenum or MoS2 on top of a technical ceramic (such as but not limited to Zirconia, Yttria, Aluminum Oxide, Chromium Oxide, Mullite, Spinel, Titania, Tungsten Carbide, or Chromium Carbide) or a metal (such as but not limited to aluminum, brass, cadmium, chromium, copper, gold, iron, molybdenum, nickel, silver, titanium, or zinc). Similar to applying a vapor deposited coating, the plasma spray coating is applied over the entire piston, or just the specific critical areas or the key areas or the essential parts (such as the outside diameter, the pin bore, the ring lands, and/or the dome). Plasma spray coating is most commonly applied on only the dome and ring lands of the piston to create a thermal barrier coating on the dome and an anti-wear surface on the ring lands.

The piston blanks are also optionally coated with a dry film coating to create anti-friction surfaces. The dry film coating is either Molybdenum Disulfide (MoS2), Tungsten Disulfide (WS2), or graphite. Similar to applying a vapor deposited coating, the dry film coating is applied to the entire piston, or just specific critical areas or key areas or integral parts (such as the outside diameter, the pin bore, the ring lands, and/or the dome). Dry film coatings are most commonly applied on just the pin bore and/or the outside diameter at the skirts of the piston to lower the coefficient of friction in these areas.

The piston blanks are also optionally coated with painting. Paints that are used are ceramic paints (such as but not Limited to Yttria stabilized Zirconia paint, Zirconia paint, or Aluminum Oxide paint), metallized paints (such as but not limited to aluminum, brass, cadmium, chromium, copper, gold, iron, molybdenum, nickel, silver, titanium, or zinc paint), anti-friction paints (such as but not limited to a MoS2 paint, pure molybdenum paint, or graphite paint), or an anti-friction paint that is layered on top of a metallized or ceramic paint. These paints typically need extra thermal or chemical treatment to burn off the plastic component and leave just the technical ceramic, metal, or anti-friction substance on the part. Similar to applying a vapor deposited coating, the paint is applied over the entire piston, or just specific critical or key or essential areas (such as the outside diameter, the pin bore, the ring lands, and/or the dome). Paint is most commonly applied on the entire surface of the piston as piston blanks are dipped into wet paint in this process.

Upon applying a relatively thick coating on the piston blanks with electroplating, plasma spray coating, dry film coating, and/or painting, certain areas may need to be finished. While the entire piston may be finish machined after adding a coating, typically, only certain critical areas or key areas or integral parts and dimensions such as the outside diameter, piston ring lands, pin bore, and/or dome height need to be finished after coating. These areas and dimensions are finished in a combination or permutation of the following methods: milling, grinding, turning, lapping, polishing, vibratory finishing, or electropolishing.

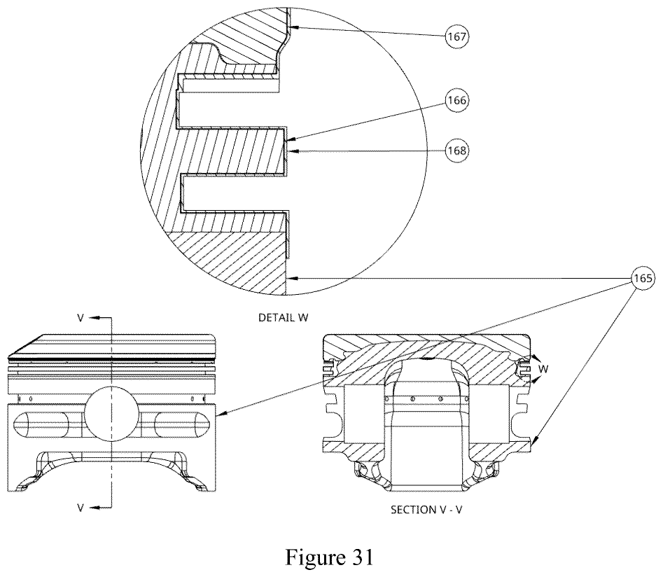

FIG. 31 illustrates geometry of a three-piece piston blank which has been coated on the dome and ring lands. The three-piece piston blank in FIG. 31 has a bottom body (165), a middle body (166), a top body (167), and a coating (168). The coating (168) is very thin and does not extend very far down past the ring lands.

During any steps of the manufacturing process described, the piston blanks are subjected to heavy metal ion implantation (HMII) treatment. HMII treatment typically occur after machining. HMII treatment that occurs before coatings is applied typically to enhance the mechanical properties of the composite part (such as by increasing stiffness, strength, and fatigue properties). On the other hand, HMII treatment that occurs after coatings is applied to enhance the effects (such as by increasing microhardness and wear resistance) of the coatings. Within the present application, HMII treatment is applied at any manufacturing step and multiple times to the piston blanks to enhance the properties that the manufacturer desires.

In the final step, the piston blanks are sealed with sodium silicate impregnation to create final pistons. Sodium silicate impregnation mitigates the undesirable hygroscopic effects experienced by the parts being treated. Sodium silicate impregnation is an important step because without sodium silicate impregnation, the FRP pistons uptake fluid (such as oil) in an engine, increasing the weight and degrading the structural integrity of the pistons. Sodium silicate impregnation is typically the last step because outgassing occurs if parts are subjected to HMII after sodium silicate impregnation. In addition, sodium silicate impregnation occurs after all machining is completed and all coatings are applied to seal the outside surfaces that are exposed to fluids within an engine.

The instant invention has been shown and described in what are the most practical and preferred method steps. It is recognized, however, that departures may be made within the scope of the invention and that modifications will occur to a person skilled in the art. With respect to the above description then, it is to be realized that the optimum dimensional relationships for the parts of the invention, to include variations in size, materials, shape, form, function, steps, and manner of operation, assembly, and use, would be apparent to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact constructions and operations shown and described, and accordingly, all suitable modifications and equivalents may be resorted to falling within the scope of the invention.

What is claimed is:

1. A method for manufacturing at least one fiber-reinforced polymer piston, the method comprising:
determining at least one dimension of the at least one fiber-reinforced polymer piston selected from: dome area, piston ring lands, pin bore area, skirt area, for designing and producing a piston body blank comprising at least 50% fiber-reinforced polymer by volume;
machining the piston body blank for integral parts of the piston to obtain a piston blank;
generating a bearing surface for a pin bore in the piston blank, the bearing surface having a surface roughness of 0-32 Ra;
finishing the piston blank to obtain the fiber-reinforced polymer piston; and
impregnating the piston with sodium silicate impregnation.

2. The method according to claim 1, producing the piston body blank further comprises building a one-piece, a two-piece, or a three-piece piston body blank.

3. The method according to claim 2, producing the piston body blank by at least one process selected from: contour compression molding; injection molding; over mold injection molding; manufacturing a standard FRP Billet Rod; and resin injection molding; or alternatively creating a standard FRP Billet Rod and machining the standard FRP Billet rod to be bonded with a thermoplastic or thermoset adhesive to one part or two parts.

4. The method according to claim 1 further comprising after finishing, subjecting the piston blank to heavy metal ion implantation treatment.

5. The method according to claim 1 further comprising after finishing, applying at least one of: a vapor deposited coating, and a plasma spray coating, on the piston blank or the integral parts, the coating is at least one selected from: a diamond-like carbon coating, a technical ceramic coating, a metal coating, and a molybdenum disulfide coating.

6. The method according to claim 1 further comprising after finishing, applying an electroplated coating on the piston blank or the integral parts, the electroplated coating is a metal selected from aluminum, brass, cadmium, chromium, copper, gold, iron, molybdenum, nickel, silver, titanium, and zinc.

7. The method according to claim 1, the integral parts comprise at least one of: outside diameter, pin bore, ring lands, and dome.

8. The method according to claim 1 further comprising after finishing, applying a painted coating to the piston blank or the integral parts, the coating is at least one selected from: a ceramic paint coating, a metallized paint coating, a pure molybdenum paint coating, a graphite paint coating, and a molybdenum disulfide paint coating.

9. The method according to claim 1 further comprising after finishing, applying an anti-friction dry film coating to the piston blank or the integral parts, the anti-friction dry film is at least one selected from: molybdenum disulfide, tungsten disulfide, and graphite.

10. The method according to claim 1 finishing the piston blank further comprises at least one process selected from: milling, grinding, turning, lapping, polishing, vibratory finishing, and electropolishing.

11. A fiber-reinforced polymer piston comprising a piston blank having at least 50% fiber-reinforced polymer by volume, the piston blank selected from a one-piece piston body blank, a two-piece piston body blank, and a three-piece piston body blank.

12. The piston body blank of claim 11 is selected from: a contour compression molded part, an injection molded part, an over mold injection molded part, a resin injection molded part, a standard FRP Billet Rod, a standard FRP Billet rod machined to be bonded with a thermoplastic or a thermoset adhesive to one part, and a standard FRP Billet rod that has been machined to be bonded with a thermoplastic or a thermoset adhesive to two parts.

13. The piston blank of claim 11 further comprising at least one of: a vapor deposited coating, and a plasma sprayed coating, of at least one material selected from: a diamond-like carbon coating, a technical ceramic coating, a metal coating, and a molybdenum disulfide coating.

14. The piston blank of claim 11 further comprising an electroplated coating of at least one metal selected from: aluminum, brass, cadmium, chromium, copper, gold, iron, molybdenum, nickel, silver, titanium, and zinc.

15. The piston blank of claim 11 comprises piston body blank having machined integral parts.

16. The piston blank of claim 11 further comprising a painted coating of at least one material selected from: a ceramic paint coating, a metallized paint coating, a pure molybdenum paint coating, a graphite paint coating, and a molybdenum disulfide paint coating.

17. The piston blank of claim 11 further comprising an anti-friction dry film coating of at least one material selected from: molybdenum disulfide, tungsten disulfide, and graphite.

18. A method for producing a fiber-reinforced polymer piston blank, the method comprising:
designing and producing a piston body blank comprising at least 50% fiber-reinforced polymer by volume;
machining the piston body blank for integral parts of the piston blank thereby obtaining the piston blanks; and
generating a bearing surface for a pin bore in the piston blank, the bearing surface having a surface roughness of 0-32 Ra.

19. The method according to claim 18, the bearing surface for the pin bore is machined into the piston blank by at least one process selected from: milling, honing, grinding, turning, lapping, polishing, vibratory finishing, and electropolishing.

20. The method according to claim 18 further comprising inserting and bonding wrist pin inserts into the pin bore, the wrist pin inserts are technical ceramic or metal.
